(19) United States
(12) Patent Application Publication
(10) Pub. No.: US 2025/0032976 A1
(43) Pub. Date: Jan. 30, 2025

(54) CONTROLLED EXPANSION OF SORBENT POLYMER COMPOSITE ARTICLE

(71) Applicant: W. L. Gore & Associates, Inc., Newark, DE (US)

(72) Inventors: Matthew T. Crouse, Elkton, MD (US); Edward H. Cully, Clarksville, VA (US); Regina M. Dell, North East, MD (US); Christine M. Scotti, Newark, DE (US)

(21) Appl. No.: 18/783,003

(22) Filed: Jul. 24, 2024

Related U.S. Application Data
(60) Provisional application No. 63/674,681, filed on Jul. 23, 2024.
(60) Provisional application No. 63/528,839, filed on Jul. 25, 2023.

(51) Int. Cl. B01D 53/14; B01D 53/04

(52) U.S. Cl. CPC B01D 53/1475; B01D 53/0407; B01D 2253/102; B01D 2253/108; B01D 2253/1124; B01D 2253/202; B01D 2253/204; B01D 2253/206; B01D 2257/504; B01D 2258/06

(57) ABSTRACT

Sorbent polymer composite articles are disclosed herein. The article includes a polymer region having a constant volume, a plurality of expandable particles disposed within the polymer region, and a plurality of compressible particles disposed within the polymer region. The expandable particles and the compressible particles have a first configuration with a first total volume of the respective particles and a second configuration with a second total volume of the respective particles greater than the first total volume. The expandable particles impart a force to the compressible particles when the expandable particles transition from the first configuration to the second configuration to compress the compressible particles from the second configuration to the first configuration to maintain the constant volume of the polymer region.

### CROSS-REFERENCE TO RELATED APPLICATIONS

This application claims the benefit of U.S. Application No. 63/528,839, filed Jul. 25, 2023, and U.S. Application No. 63/674,681, filed Jul. 23, 2024, which are incorporated herein by reference in their entireties for all purposes.

### FIELD

The present disclosure relates to sorbent polymer composite articles and methods of using the same, including adsorption and desorption for the process of direct air capture (DAC) of carbon dioxide.

### BACKGROUND

Increasing carbon dioxide (CO₂) levels associated with greenhouse emissions are shown to be harmful to the environment. In recent years, the average carbon dioxide level in the atmosphere was increased to the highest level that has been noted in the past 800,000 years. The rate of increase of CO₂ in the atmosphere is also much higher than the rates in previous decades.

In order to limit the impact of climate change, it is not only necessary to reduce CO₂ emissions in the near future to zero but also to achieve negative CO₂ emissions, for example via direct air capture (DAC) of CO₂ from the atmosphere. Capturing CO₂ directly from the atmosphere is one of several means of mitigating anthropogenic greenhouse gas emissions and has attractive economic prospects as a non-fossil, location-independent CO₂ source for the commodity market and for the production of synthetic fuels. The specific advantages of CO₂ capture from the atmosphere include: a) DAC can address the emissions of distributed sources (e.g. vehicles on land, sea, and/or air), which account for a large portion of the worldwide greenhouse gas emissions and can currently not be captured at the site of emission in an economically feasible way; b) DAC can address legacy emissions and can therefore create truly negative emissions; and c) DAC systems do not need to be attached to the source of emission but may be location independent and can be located at the site of further CO₂ processing or usage.

### SUMMARY

Sorbent polymer composite articles and assemblies thereof are described including a plurality of expandable articles and compressible articles, where the sorbent articles are configured to adsorb CO₂ during adsorption processes, such as during direct air capture (DAC) of CO₂, for example. Disclosed herein are methods to control the growth or expansion of sorbent polymer composite materials where the material swells via contact with water or other liquids. Controlled material includes materials that allow for swelling of the sorbent particles or materials that restrict swelling of the sorbent particles for system design advantages. Controlling composite material growth may beneficially enable material durability for a longer cycle lifetime (such as the increased number of cycles before material replacement is needed). Controlling composite material growth in one direction can beneficially allow the material growth to be used to identify when material has picked up a given amount of water or liquid. For example, such identification may be valuable with adsorption and regeneration with temperature, steam, vacuum, and/or water cycling for DAC events.

According to one example (“Example 1”), a sorbent polymer composite article includes a polymer region having a constant volume, a plurality of expandable particles disposed within the polymer region, and a plurality of compressible particles disposed within the polymer region. The plurality of expandable particles have a first configuration with a first total volume of the plurality of expandable particles and a second configuration with a second total volume of the plurality of expandable particles greater than the first total volume of the plurality of expandable particles. The plurality of compressible particles have a first configuration with a first total volume of the plurality of compressible particles and a second configuration with a second total volume of the plurality of compressible particles greater than the first total volume of the plurality of compressible particles. The plurality of expandable particles impart a force to the plurality of compressible particles when the plurality of expandable particles transition from the first configuration of the plurality of the expandable particles to the second configuration of the plurality of expandable particles to compress the plurality of compressible particles from the second configuration of the plurality of compressible particles to the first configuration of the plurality of compressible particles to maintain the constant volume of the polymer region.

According to another example (“Example 2”) further to Example 1, the polymer region includes a porous polymer configured to hold the plurality of expandable particles and the plurality of compressible particles inside the polymer region.

According to another example (“Example 3”) further to Example 1 or 2, the plurality of expandable particles have the first configuration of the plurality of expandable particles during an adsorption process and the second configuration of the plurality of expandable particles during a desorption process.

According to another example (“Example 4”) further to Example 3, the adsorption process and the desorption process are cyclical.

According to another example (“Example 5”) further to Example 1 or 2, the plurality of expandable particles change from having the first configuration of the plurality of expandable particles to having the second configuration of the plurality of expandable particles in response to an increase in humidity.

According to another example (“Example 6”) further to Example 5, the increase in humidity is in response to changing from an adsorption process to a desorption process or during the desorption process.

According to another example (“Example 7”) further to Example 5, the plurality of expandable particles change from having the first configuration of the plurality of expandable particles to having the second configuration of the plurality of expandable particles in response to a decrease in temperature to below a freezing point of water.

According to another example (“Example 8”) further to any one of the preceding Examples, the plurality of expandable particles are made of one or more of: an ion exchange resin, zeolite, activated carbon, alumina, metal-organic frameworks, or polyethyleneimine (PEI).

According to another example (“Example 9”) further to any one of the preceding Examples, the plurality of compressible particles are made of one or more of: foams, expanded polystyrene beads, or latex microspheres.

According to another example (“Example 10”) further to any one of the preceding Examples, the article further includes a plurality of structurally stable particles disposed within the polymer region.

According to another example (“Example 11”) further to Example 10, the structurally stable particles are configured to provide protection for the sorbent polymer composite article from mixing with water.

According to another example (“Example 12”) further to Example 10, the structurally stable particles are configured to provide protection for the sorbent polymer composite article from oxidation.

According to another example (“Example 13”) further to Example 10, the structurally stable particles are configured to facilitate heating of the sorbent polymer composite article.

According to another example (“Example 14”) further to any one of Examples 10-13, the structurally stable particles include a combination of one or more of: ceramic particles, metal particles, or graphite particles.

According to one example (“Example 15”), a sorbent polymer composite article includes a polymer region and a plurality of expandable particles. The polymer region has a constant volume and defines a plurality of interstitial spaces therein having a first configuration with a first total volume of the plurality of interstitial spaces and a second configuration with a second total volume of the plurality of interstitial spaces greater than the first total volume. The plurality of expandable particles are disposed within a portion of the interstitial spaces. The plurality of expandable particles have a first configuration with a first total volume of the plurality of expandable particles and a second configuration with a second total volume of the plurality of expandable particles greater than the first total volume. The plurality of expandable particles impart a force to the plurality of interstitial spaces when the plurality of expandable particles transition from the first configuration of the plurality of the expandable particles to the second configuration of the plurality of expandable particles to compress the plurality of interstitial spaces from the second configuration of the plurality of interstitial spaces to the first configuration of the plurality of interstitial spaces to maintain the constant volume of the polymer region.

According to another example (“Example 16”) further to Example 15, the polymer region includes a porous polymer configured to hold the plurality of expandable particles inside the polymer region.

According to another example (“Example 17”) further to Example 15 or 16, the plurality of expandable particles have the first configuration of the plurality of expandable particles during an adsorption process and the second configuration of the plurality of expandable particles during a desorption process.

According to another example (“Example 18”) further to Example 17, the adsorption process and the desorption process are cyclical.

According to another example (“Example 19”) further to Example 15 or 16, the plurality of expandable particles change from having the first configuration of the plurality of expandable particles to having the second configuration of the plurality of expandable particles in response to an increase in humidity.

According to another example (“Example 20”) further to Example 19, the increase in humidity is in response to changing from an adsorption process to a desorption process or during the desorption process.

According to another example (“Example 21”) further to Example 19, the plurality of expandable particles change from having the first configuration of the plurality of expandable particles to having the second configuration of the plurality of expandable particles in response to a decrease in temperature to below a freezing point of water.

According to another example (“Example 22”) further to any one of Examples 15-21, the plurality of expandable particles are made of one or more of: an ion exchange resin, zeolite, activated carbon, alumina, metal-organic frameworks, or polyethyleneimine (PEI).

According to another example (“Example 23”) further to any one of Examples 15-22, the plurality of expandable particles occupy no greater than about 50% of the second total volume of the plurality of interstitial spaces of the polymer region.

According to another example (“Example 24”) further to any one of Examples 15-23, the article further includes a plurality of structurally stable particles disposed within the polymer region. The force imparted by the plurality of expandable particles pushes the plurality of structurally stable particles into the plurality of interstitial spaces.

According to another example (“Example 25”) further to Example 24, the structurally stable particles are configured to provide protection for the sorbent polymer composite article from mixing with water.

According to another example (“Example 26”) further to Example 24, the structurally stable particles are configured to provide protection for the sorbent polymer composite article from oxidation.

According to another example (“Example 27”) further to Example 24, the structurally stable particles are configured to facilitate heating of the sorbent polymer composite article.

According to another example (“Example 28”) further to any one of Examples 24-27, the structurally stable particles include one or more of: ceramic particles, metal particles, or graphite particles.

According to another example (“Example 29”) further to any one of Examples 15-28, the article further includes a plurality of compressible particles disposed within the polymer region and configured to absorb at least a portion of the force imparted by the plurality of expandable particles.

According to one example (“Example 30”), a sorbent polymer composite article includes a first configuration and a second configuration. The first configuration has a first transverse length, a first longitudinal length, and a first total volume. The second configuration has a second transverse length greater than the first transverse length, a second longitudinal length that is no less than the first longitudinal length, and a second total volume greater than the first total volume. A change from the first transverse length to the second transverse length is greater than a change from the first longitudinal length to the second longitudinal length.

According to another example (“Example 31”) further to Example 30, the article has the first configuration during an adsorption process and the second configuration during a desorption process.

According to another example (“Example 32”) further to Example 30, the desorption process is configured to be controlled or modified in response to a sensor component detecting that the second transverse length of the article exceeds a predetermined threshold.

According to another example (“Example 33”) further to Example 30, the adsorption process and the desorption process are cyclical processes.

According to another example (“Example 34”) further to Example 33, the cyclical processes including the adsorption process and the desorption process are facilitated in response to a sensor component detecting the change of the article from the first transverse length to the second transverse length.

According to another example (“Example 35”) further to any one of Examples 30-34, the first longitudinal length is substantially the same as the second longitudinal length.

According to another example (“Example 36”) further to any one of Examples 30-35, the article includes: at least one backer material or at least one uniaxial tape.

According to one example (“Example 37”), a direct air capture (DAC) system includes at least one sorbent polymer composite article, a sensor component, and a controller. The sorbent polymer composite article has: a first configuration with a first transverse length, a first longitudinal length, and a first total volume, and a second configuration with a second transverse length greater than the first transverse length, a second longitudinal length that is no less than the first longitudinal length, and a second total volume greater than the first total volume. A change from the first transverse length to the second transverse length is greater than a change from the first longitudinal length to the second longitudinal length. The sensor component is operatively coupled with the article and is configured to detect the change of the article from the first transverse length to the second transverse length. The controller is operatively coupled with the sensor component and is configured to control an operation of the article based upon the detection by the sensor component.

According to another example (“Example 38”) further to Example 37, the system includes a housing defining a space in which the at least one sorbent polymer composite article is disposed. The at least one sorbent polymer composite article comprises a first end and a second end, the first end is attached to the housing in the space, and the second end is a free end that remains free to expand or extend away from the first end based on the change from the first transverse length to the second transverse length.

According to another example (“Example 39”) further to Example 38, the at least one sorbent polymer composite article includes a plurality of sorbent polymer composite articles positioned in a parallel configuration with respect to each other.

According to another example (“Example 40”) further to any one of Examples 37-39, the controller is configured to facilitate a cyclical process including the adsorption process and the desorption process.

According to another example (“Example 41”) further to any one of Examples 37-40, the controller is configured to control or modify the desorption process in response to the sensor component detecting that the second transverse length of the article exceeds a predetermined threshold.

According to one example (“Example 42”), a sorbent polymer composite article includes: at least one first region with a first density and a first porosity; and at least one second region with a second density greater than the first density and a second porosity less than the first porosity such that the at least one second region is more dimensionally stable than the at least one first region.

According to another example (“Example 43”) further to Example 42, the second region is formed by compressing or densifying a base material comprising the article, wherein the first region and the second region are formed of the base material.

According to another example (“Example 44”) further to Example 43, the first region and the second region are two different alternative forms of the base material.

According to another example (“Example 45”) further to Example 44, the first region comprises expanded polytetrafluoroethylene (ePTFE) and the second region comprises polytetrafluoroethylene (PTFE), wherein the base material comprises both the PTFE and ePTFE.

According to another example (“Example 46”) further to Example 45, the first region comprises expanded polyethylene (ePE) and the second region comprises polyethylene (PE), wherein the base material comprises both the PE and ePE.

According to another example (“Example 47”) further to any one of Examples 42-45, the second region has a greater structural integrity or stiffness than the first region.

According to another example (“Example 48”) further to any one of Examples 42-45, the second region has a crisscross pattern on a surface of the article.

According to another example (“Example 49”) further to any one of Examples 42-48, the second region has a striped pattern on a surface of the article.

According to another example (“Example 50”) further to Example 49, the striped pattern includes a plurality of substantially parallel regions.

According to another example (“Example 51”) further to Example 50, the striped pattern further includes a plurality of bridge regions formed between neighboring parallel regions of the plurality of substantially parallel regions.

According to another example (“Example 52”) further to any one of Examples 42-51, the second region has a combination of crisscross and striped patterns on a surface of the article.

According to another example (“Example 53”) further to any one of Examples 42-52, the first region is substantially opaque and the second region is substantially translucent or transparent.

According to another example (“Example 54”) further to any one of Examples 42-53, the first region having a first configuration with a first total volume during an adsorption process and a second configuration with a second total volume greater than the first total volume during a desorption process.

According to another example (“Example 55”) further to Example 54, a total volume of the second region remains substantially the same during the desorption process and the adsorption process.

According to one example (“Example 56”), a sorbent polymer composite assembly includes a housing, a plurality of sorbent polymer composite sheets, a plurality of spacers, and a plurality of gaskets. The housing is configured to provide structural support and defining an inner chamber. The plurality of sorbent polymer composite sheets are disposed within the inner chamber of the housing and have a first configuration with a first total volume and a second configuration with a second total volume greater than the first total volume. The plurality of spacers are disposed between neighboring sheets of the plurality of sorbent polymer composite sheets and have a first configuration with a first total volume and a second configuration with a second total volume greater than the first total volume. The plurality of gaskets are disposed between the sheets and the inner chamber of the housing and have a first configuration with a first total volume and a second configuration with a second total volume greater than the first total volume. The spacers and the gaskets have the first configuration in response to the sheets having the second configuration, and the spacers and the gaskets have the second configuration in response to the sheets having the first configuration.

According to another example (“Example 57”) further to Example 56, the spacers and the gaskets are integral to the housing.

According to another example (“Example 58”) further to Example 56 or 57, the gaskets are integral to an insertable component configured to be inserted into the housing to at least partially define the inner chamber of the housing.

According to another example (“Example 59”) further to Example 58, the spacers are also integral to the insertable component.

According to another example (“Example 60”) further to any one of Examples 56-59, the spacers include one or more of: foams, springs, or compliant polymer pieces.

According to another example (“Example 61”) further to any one of Examples 56-60, the gaskets are made of a compliant material.

According to one example (“Example 62”), a sorbent polymer composite article includes a container and a sorbent polymer mixture disposed within the container. The sorbent polymer mixture includes: a plurality of sorbent particles structured to adsorb and desorb CO₂, and a plurality of additive particles mixed with the plurality of sorbent particles. The additive particles include at least a plurality of hydrophobic particles mixed with the plurality of sorbent particles and structured to exert hydrophobic force to expel liquid water from the sorbent article. The sorbent particles occupy at least 80% of a total volume of the sorbent polymer mixture, and the additive particles occupy no greater than 20% of the total volume of the sorbent polymer mixture.

According to another example (“Example 63”) further to Example 62, the sorbent particles and the additive particles are maintained in an intermixed distribution within the container.

According to another example (“Example 64”) further to Example 62 or 63, the container includes a drain through which the liquid water is expelled from the article.

According to another example (“Example 65”) further to any one of Examples 62-64, the sorbent particles and the additive particles are discrete and loosely packed within the container.

According to another example (“Example 66”) further to Example 63, at least a portion of the hydrophobic particles form a network of hydrophobic particles.

According to another example (“Example 67”) further to Example 66, the network defines a plurality of interstitial spaces within the network and at least some of the sorbent particles are disposed within the interstitial spaces defined by the network.

According to another example (“Example 68”) further to Example 66 or 67, the network is entrained in a structure having a plurality of hydrophobic nodes and fibrils.

According to another example (“Example 69”) further to Example 68, the structure is at least partially contained within the container and is structured to facilitate restricting movement of the additive particles with respect to the sorbent particles to maintain the intermixed distribution.

According to another example (“Example 70”) further to any one of Examples 62-69, the article further includes at least one hydrophobic layer disposed adjacent to the sorbent polymer mixture.

According to another example (“Example 71”) further to Example 70, the article includes two porous hydrophobic layers such that the sorbent polymer mixture is disposed between the two porous hydrophobic layers.

According to another example (“Example 72”) further to Example 69 or 70, the hydrophobic layer has a first permeability with respect to water vapor that is greater than a second permeability with respect to liquid water, wherein the liquid water is formed as result of condensation of the water vapor within the article.

According to another example (“Example 73”) further to Example 72, the second permeability is defined such that the hydrophobic layer is impermeable with respect to the liquid water under atmospheric pressure.

According to another example (“Example 74”) further to any one of Examples 70-73, the hydrophobic particles are configured to exert sufficient hydrophobic force to expel the liquid water through the hydrophobic layer.

According to another example (“Example 75”) further to any one of Examples 62-74, the hydrophobic particles are configured to exert the hydrophobic force against liquid water located on a surface of the article to facilitate reducing an amount of liquid water entering the article.

According to another example (“Example 76”) further to any one of Examples 62-75, the hydrophobic particles include a first plurality of hydrophobic particles having a first hydrophobicity and a second plurality of hydrophobic particles of a material different from the first plurality of hydrophobic particles characterized by a second hydrophobicity that is different from the first hydrophobicity.

According to another example (“Example 77”) further to Example 76, the second plurality of hydrophobic particles are different in size or shape from the first plurality of hydrophobic particles.

According to another example (“Example 78”) further to any one of Examples 62-77, the additive particles are configured to provide protection for the sorbent polymer composite article from mixing with water.

According to another example (“Example 79”) further to any one of Examples 62-77, the additive particles are configured to provide protection for the sorbent polymer composite article from oxidation.

According to another example (“Example 80”) further to any one of Examples 62-77, the additive particles are configured to facilitate heating of the sorbent polymer composite article.

According to another example (“Example 81”) further to any one of Examples 62-80, the additive particles further include a combination of one or more of: ceramic particles, metal particles, or graphite particles.

According to another example (“Example 82”) further to any one of Examples 62-81, the sorbent polymer mixture is distributed homogeneously within the container.

According to another example (“Example 83”) further to any one of Examples 62-81, the sorbent polymer mixture is distributed within the container such that a first portion of the container includes a greater concentration of the sorbent particles than the additive particles, and a second portion of the container includes a greater concentration of the additive particles than the sorbent particles.

According to another example (“Example 84”) further to any one of Examples 62-81, the sorbent polymer mixture includes a temporary binder configured to temporarily bind together the sorbent particles and the additive particles and form a stiff composite.

According to another example (“Example 85”) further to Example 84, the temporary binder is dissolvable in response to applying a dissolving liquid to the stiff composite.

According to one example (“Example 86”), a method for removing gaseous carbon dioxide from an atmosphere includes: receiving information about a dispersion of a first quantity of gaseous carbon dioxide into the atmosphere at a first location; initiating a method of separating a second quantity of gaseous carbon dioxide from the atmosphere at a second location, the second quantity being at least a portion of the first quantity, wherein the method of separating includes the use of the article of any one of Examples 1-36, 42-55, and 62-85, the system of any one of Examples 37-41, or the assembly of any one of Examples 56-61; and initiating a reporting of data regarding the second quantity.

According to one example (“Example 87”), a method for removing gaseous carbon dioxide from an atmosphere includes: receiving information about a first quantity of gaseous carbon dioxide; separating a second quantity of gaseous carbon dioxide from the atmosphere, the second quantity being at least a portion of the first quantity, wherein the method of separating includes the use of the article of any one of Examples 1-36, 42-55, and 62-85, the system of any one of Examples 37-41, or the assembly of any one of Examples 56-61; and reporting data regarding the second quantity.

According to one example (“Example 88”), a method for removing gaseous carbon dioxide from an atmosphere includes: transmitting information about a dispersion of a first quantity of gaseous carbon dioxide into the atmosphere at a first location; requesting initiation of a method of separating a second quantity of gaseous carbon dioxide from the atmosphere at a second location, the second quantity being at least a portion of the first quantity, wherein the method of separating includes the use of the article of any one of Examples 1-36, 42-55, and 62-85, the system of any one of Examples 37-41, or the assembly of any one of Examples 56-61; and receiving a reporting of data regarding the second quantity.

According to one example (“Example 89”), a method for removing gaseous carbon dioxide from an atmosphere includes: receiving, from a computing device, a first electronic communication comprising information about a dispersion of a first quantity of gaseous carbon dioxide into the atmosphere at a first location; initiating a separating, by a carbon capture device, of a second quantity of gaseous carbon dioxide from the atmosphere at a second location, the second quantity being at least a portion of the first quantity, wherein the carbon capture device includes the article of any one of Examples 1-36, 42-55, and 62-85, the system of any one of Examples 37-41, or the assembly of any one of Examples 56-61; and initiating a reporting of data associated with the carbon capture device regarding the second quantity, wherein the data forms part of a second electronic communication.

According to another example (“Example 90”) further to Example 89, the second electronic communication is transmitted to the computing device.

According to another example (“Example 91”) further to Example 89 or 90, the second electronic communication is transmitted to an additional computing device.

According to one example (“Example 92”), a method for removing gaseous carbon dioxide from an atmosphere includes: receiving, from a computing device, a first electronic communication comprising information about a first quantity of gaseous carbon dioxide; separating, by a carbon capture device, a second quantity of gaseous carbon dioxide from the atmosphere, the second quantity being at least a portion of the first quantity, wherein the carbon capture device includes the article of any one of Examples 1-36, 42-55, and 62-85, the system of any one of Examples 37-41, or the assembly of any one of Examples 56-61; and reporting, as a second electronic communication, data associated with the carbon capture device regarding the second quantity.

According to another example (“Example 93”) further to Example 92, the second electronic communication is transmitted to the computing device.

According to another example (“Example 94”) further to Example 92 or 93, the second electronic communication is transmitted to an additional computing device.

According to one example (“Example 95”), a method for removing gaseous carbon dioxide from an atmosphere includes: transmitting, to a computing device, a first electronic communication comprising information about a dispersion of a first quantity of gaseous carbon dioxide into the atmosphere at a first location; requesting a separating, by a carbon capture device, of a second quantity of gaseous carbon dioxide from the atmosphere at a second location, the second quantity being at least a portion of the first quantity, wherein the carbon capture device includes the article of any one of Examples 1-36, 42-55, and 62-85, the system of any one of Examples 37-41, or the assembly of any one of Examples 56-61; and receiving a second electronic communication comprising an indication of a reporting of data associated with the carbon capture device regarding the second quantity.

According to another example (“Example 96”) further to Example 95, the second electronic communication is received from the computing device.

According to another example (“Example 97”) further to Example 95 or 96, the second electronic communication is received in response to transmitting the first electronic communication.

According to one example (“Example 98”), a method for removing gaseous carbon dioxide from an atmosphere includes: receiving information about a dispersion of a first quantity of gaseous carbon dioxide into the atmosphere at a first location; initiating a separating of a second quantity of gaseous carbon dioxide from the atmosphere at a second location, the second quantity being at least a portion of the first quantity, wherein the separating includes the use of the article of any one of Examples 1-36, 42-55, and 62-85, the system of any one of Examples 37-41, or the assembly of any one of Examples 56-61; and initiating a reporting of data regarding the second quantity.

According to one example (“Example 99”), a method for removing gaseous carbon dioxide from an atmosphere includes: transmitting information about a dispersion of a first quantity of gaseous carbon dioxide into the atmosphere at a first location; requesting a separating a second quantity of gaseous carbon dioxide from the atmosphere at a second location, the second quantity being at least a portion of the first quantity, wherein the separating includes the use of the article of any one of Examples 1-36, 42-55, and 62-85, the system of any one of Examples 37-41, or the assembly of any one of Examples 56-61; and receiving a reporting of data regarding the second quantity.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIGS. 1A and 1B are schematic diagrams of a sorbent article in two different configurations during different stages of adsorption and desorption according to embodiments disclosed herein;

FIGS. 2A and 2B are schematic diagrams of a sorbent article in two different configurations during different stages of adsorption and desorption according to embodiments disclosed herein;

FIGS. 3A and 3B are schematic diagrams of a sorbent article in two different configurations during different stages of adsorption and desorption according to embodiments disclosed herein;

FIG. 4A is a top view of a sorbent article according to embodiments disclosed herein;

FIG. 4B is a side view of a portion of the sorbent article of FIG. 4A according to embodiments disclosed herein;

FIG. 5A is a top view of a sorbent article according to embodiments disclosed herein;

FIG. 5B is a side view of a portion of the sorbent article of FIG. 5A according to embodiments disclosed herein;

FIG. 6A is an isometric image of a front view of a sorbent article assembly according to embodiments disclosed herein;

FIGS. 6B through 6D are schematic diagrams of different configurations of the sorbent article assembly shown in FIG. 6A according to embodiments disclosed herein;

FIGS. 7A and 7B are schematic diagrams of a sorbent article assembly or system in different configurations during different stages of adsorption and desorption according to embodiments disclosed herein;

FIGS. 8A and 8B are schematic diagrams of a sorbent article in two different configurations during different stages of adsorption and desorption according to embodiments disclosed herein;

FIG. 9 is an SEM image of a polymeric material which may be used as the particles as disclosed according to embodiments disclosed herein (the image is to scale);

FIGS. 10A and 10B are schematic diagrams of sorbent articles having particles and filaments according to embodiments disclosed herein;

FIG. 11 is a schematic diagram of a sorbent article having a mixture of particles that are homogeneously distributed according to embodiments disclosed herein;

FIG. 12 is a schematic diagram of a sorbent article having a mixture of particles that are distributed to have different concentrations of the particles according to embodiments disclosed herein;

FIG. 13 is a schematic diagram of a sorbent article having a mixture of particles with a portion that is filled with a temporary binder and a portion that is absent of the binder;

FIG. 14 is a schematic diagram of a sorbent article having with a drain according to embodiments disclosed herein; and

FIG. 15 is a graph of techno-economic analysis (TEA) score as calculated with respect to an amount of sorbent in a given space according to embodiments disclosed herein.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant art. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant art would not readily ascertain values for such reasonably small differences, the terms “about” and “approximately” can be understood to mean plus or minus 10% of the stated value.

The term “node” as used herein describes a connection point of at least two fibrils, where the connection may be defined as a location where the two fibrils come into contact with each other, permanently or temporarily. In some examples, a node may also be used to describe a larger volume of polymer than a fibril and where a fibril originates or terminates with no clear continuation of the same fibril through the node. In some examples, a node has a greater width but a smaller length than the fibril.

The term “fibril” as used herein describes an elongated piece of material such as a polymer, where the length and width are substantially different from each other. For example, a fibril may resemble a piece of string or fiber, where the width (or thickness) is much shorter or smaller than the length. As used herein, “nodes” and “fibrils” may be used to describe objects that are usually, but not necessarily, connected or interconnected, and have a microscopic size, for example.

A “microscopic” object may be defined as an object with at least one dimension (width, length, or height) that is substantially small such that the object or the detail of the object is not visible to the naked eye or difficult, if not impossible, to observe without the aid of a microscope (including but not limited to a scanning electron microscope or SEM, for example) or any suitable type of magnification device.

### Description of Various Embodiments

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale (unless indicated otherwise) but may be exaggerated to illustrate various aspects of the present disclosure, and in that regard, the drawing figures should not be construed as limiting.

The present disclosure relates to sorbent article assemblies as well as systems incorporating the same and methods of forming and operating such assemblies. While the sorbent article is described below for use in capture of CO₂ from an air feed stream, for example, it may be used in other adsorbent methods and applications. These methods include, but are not limited to, adsorption of substances from various inputs, including other gas feed streams (e.g., combustion exhaust) and liquid feed streams (e.g., ocean water). The adsorbed substance is not limited to CO₂. Other adsorbed substances may include, but are not limited to, other gas molecules (e.g., N₂, CH₄, and CO), liquid molecules, and solutes. In certain embodiments, the input may be dilute, containing on the order of parts per million (ppm) of the desired substance. The disclosures of U.S. application Ser. No. 18/101,736 and International Application No. PCT/US2023/011599, both filed on Jan. 26, 2023 and assigned to W. L. Gore & Associates, Inc., are incorporated herein by reference in their entireties for all purposes.

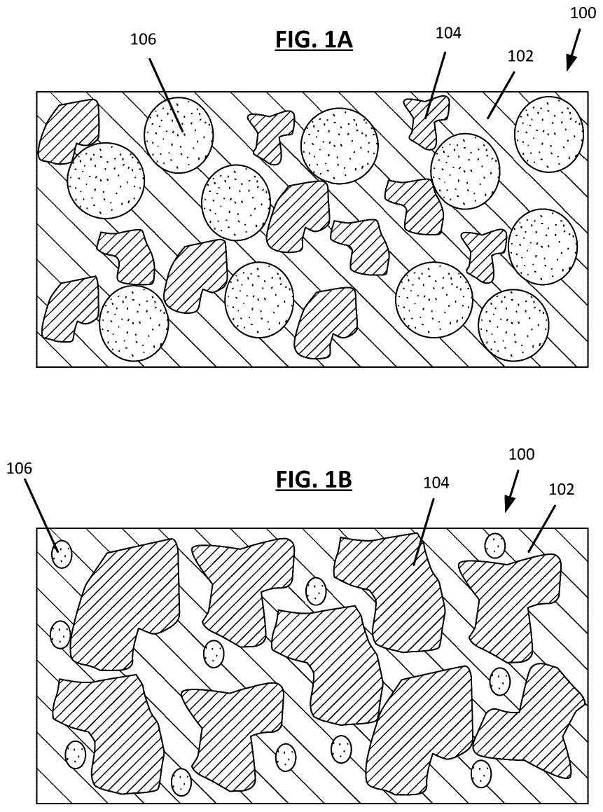

FIGS. 1A and 1B illustrate a sorbent polymer composite article 100 which may be used in for example direct air capture (DAC) system or carbon dioxide sorbent assembly as further described herein. The article 100 includes a polymer region 102, primary particles 104, and secondary particles 106. The primary particles 104 may alternatively be referred to herein as “sorbent polymer articles” or “expandable particles,” for example. The secondary particles 106 may alternatively be referred to herein as “compressible particles” or “reactionary particles,” for example.

The particles 104 and 106 are disposed within the polymer region 102, which has a substantially constant volume. That is, the total volume of the polymer region 102 is constant throughout the use of the article 100, for example during both adsorption and desorption phases or stages of the DAC process. In some examples, the constant volume may be defined by the total volume of the polymer region 102 changing (e.g., increasing or decreasing) by less than about 10%, less than about 5%, or less than about 1%, or any other suitable range or value therebetween.

The particles 104 may have a first configuration with a first total volume of the particles 104 (as shown in FIG. 1A) and a second configuration with a second total volume of the particles 104 (as shown in FIG. 1B). The second total volume is greater than the first total volume of the particles 104. The particles 106 may have a first configuration with a first total volume of the particles 106 and a second configuration with a second total volume of the particles 106. The second total volume is greater than the first volume of the particles 106. In some examples, the particles 104 impart a force to the particles 106 when the particles 104 transition from the first configuration of the particles 104 to the second configuration of the particles 104. The force imparted by the particles 104 compresses the particles 106 from the second configuration of the particles 106 to the first configuration of the particles 106 to maintain the constant volume of the polymer region 102. As such, the particles 106 may be defined as being reactionary due to being compressed in reaction to or in response to the expansion of the particles 104.

As used herein, the first and second configurations may have different total volumes with respect to each other. For example, the second total volume may be from about 110% to about 120%, from about 120% to about 130%, from about 130% to about 140%, from about 140% to about 150%, from about 150% to about 160%, from about 160% to about 170%, from about 170% to about 180%, from about 180% to about 190%, from about 190% to about 200%, from about 200% to about 250%, from about 250% to about 300%, from about 300% to about 400%, from about 400% to about 500%, or any other suitable value or range therebetween or combination of ranges thereof, with respect to the first total volume.

In some examples, the polymer region 102 includes a porous polymer that holds the particles 104 and 106 inside the polymer region 102. The porous polymer may be formed as a network of nodes and fibrils.

For example, the network may be a microstructure of a plurality of nodes and a plurality of fibrils that connect adjacent nodes. In these instances, the porous polymer includes pores bordered by the fibrils and the nodes. An exemplary node and fibril microstructure is described in U.S. Pat. No. 3,953,566 assigned to W. L. Gore & Associates Inc., incorporated herein by reference in its entirety. The pores of the porous polymer may be considered micropores. Such micropores may have a single pore size or a distribution of pore sizes. The average pores size may range from 0.1 microns to 100 microns in certain embodiments.

As further explained herein, the primary particles 104 may be sorbent particles made of one or more sorbent polymer materials. In such cases, the particles 104 may have the first configuration during an adsorption process and may have the second configuration during a desorption process, for example as part of a DAC process. In some examples, the adsorption and desorption processes are cyclical, for example such that a desorption process follows after each adsorption process and vice versa, to be continued until the process is halted altogether.

In some examples, the primary particles 104 may change from having the first configuration to having the second configuration in response to an increase in humidity. For example, the change in the configuration may be a result of the particles 104 swelling due to absorbing water vapor in the environment or inside the article 100 such that an increase in the amount of water vapor causes the swelling or expansion of the particles 104. The secondary particles 106, however, does not absorb water vapor and may remain constant in volume or size regardless of humidity, such that when the primary particles 104 expand, they exert a force onto the secondary particles 106, causing the secondary particles 106 to be compressed. In some examples, the increase in humidity may be in response to changing from an adsorption process to a desorption process or during the desorption process of the DAC process, such that the change from the adsorption process to the desorption process may be a catalyst to cause the primary particles 104 to expand and exert force onto the secondary particles 106. Furthermore, the change from the desorption process back to the adsorption process, or a decrease in humidity, may cause the primary particles 104 to revert back to the first configuration with a smaller total volume, which in turn causes the secondary particles 106 to revert back to the second configuration having a greater total volume.

In some examples, the primary particles 104 may change from having the first configuration to having the second configuration in response to a decrease in temperature to below a freezing point of water. As water expands when frozen, such as at 0° C. under the pressure of 1 atmosphere (atm) or any other suitable temperature under a different pressure, the primary particles 104 which contain water also expand. When the temperature subsequently increases, the frozen water begins to melt until the density of water reaches its maximum (which may be at 4° C. under the pressure of 1 atm) thereby causing the volume of water to decrease, which also causes the primary particles 104 to transition from the second configuration to the first configuration.

In some examples, the particles 104 and 106 include a blend of particles having different physical properties and/or materials. In some examples, the secondary particles 106 may be made of, for example, a foam including but not limited to polyurethane, polystyrene beads, and/or latex microspheres, among others. The foam may be closed-cell or open-cell. In some examples, the secondary particles 106 are weaker than the force exerted on it by the primary particles 104. In some examples, the secondary particles 106 are weaker than the material forming the polymer region 102. In some examples, the secondary particles 106 define the most compressible portions of the composite article 100, that is, the secondary particles 106 may be formed using the most compressible, flexible, or pliable material than any other component of the article 100, including the polymer region 102 and the primary particles 104.

In some examples, the polymer region 102 may include metal or other non-polymeric materials. In some examples, the polymer region 102 may include structures made of metallic material such as a metallic mesh structure or contain metallic particles embedded inside the network, for example for providing structural support for the article 100.

Controlled swelling or expansion may beneficially enable use of other sorbents that are moisture/water sensitive without the aid of a separate housing, in view of the self-sustaining nature of the polymer region 102. Examples described herein may allow users to design a structure that allows sorbent material to absorb only the amount of water as desired by the user, which may beneficially lead to controlling the amount of water that is to be absorbed, such as maintaining the sorbent materials moist but not entirely wet. In some examples, composite materials may beneficially be constructed in a way that minimizes the blocking off of surface area of such sorbent particles such as the primary particles 104. In some examples, the particles 104 may be made of folded polymer fibrils to include a stored length allowing the particles 104 to deform with minimal stress upon swelling. In some examples, construction of a sorbent composite article 100 may be facilitated while the sorbent material (e.g., the particles 104) is in a swelled state (second configuration) such that the final product of the article 100 includes a built-in space to allow for the particles 104 to swell or expand. For example, the final product of the article 100 may restrict the material of the particles 104 from shrinking, thus providing space when sorbent composite article 100 dries, or the article 100 may allow the composite material (e.g., of the particles 104) to shrink, in order to minimize material strain upon cyclic deformation during the DAC process. As such, it is advantageous to allow the particles 104 to swell or expand in a controlled manner as disclosed herein.

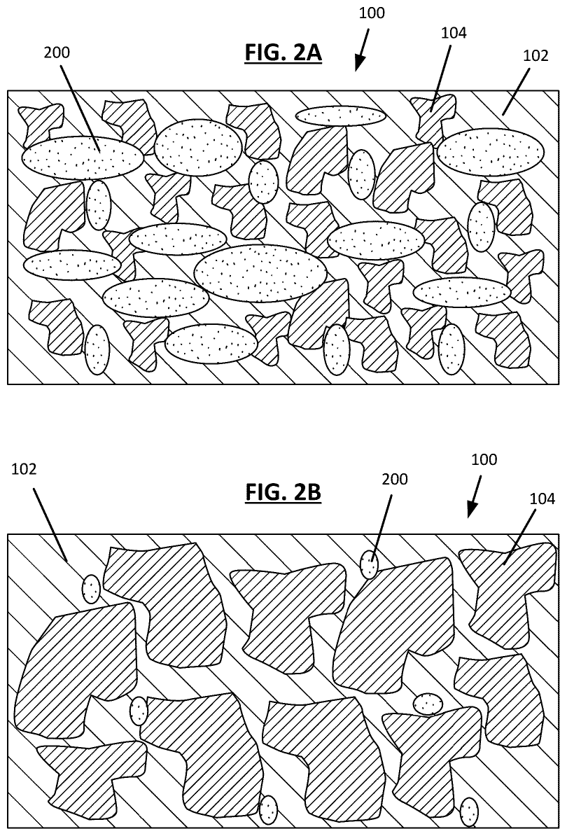

FIGS. 2A and 2B illustrate a sorbent polymer composite article 100 which may be used in for example the DAC system or carbon dioxide sorbent assembly as further described herein. The article 100 includes a polymer region 102 having a constant volume and defining interstitial spaces 200. The article 100 also includes the particles 104 as described above, which are disposed within a portion of the interstitial spaces 200 of the polymer region 102. The interstitial spaces 200 have a first configuration with a first total volume of the interstitial spaces 200 (as shown in FIG. 2B) and a second configuration with a second total volume of the interstitial spaces 200 (as shown in FIG. 2A). The second total volume is greater than the first total volume. In some examples, the total volume with respect to the interstitial spaces 200 may refer to a total volume of the spaces that remains unoccupied by the primary particles 104. That is, the first and second total volumes of the interstitial spaces 200 may refer to the total “empty” or “unoccupied” volumes, thereby excluding the volumes of the interstitial spaces 200 in which the particles 104 are already disposed.

In some examples, the particles 104 impart a force to the plurality of interstitial spaces 200 when the particles 104 transition from the first configuration of the particles 104 to the second configuration of the particles 104. The force imparted by the particles 104 compresses the interstitial spaces 200 from the second configuration to the first configuration to maintain the constant volume of the polymer region 102. In some examples, some of the interstitial spaces 200 contain one or more of the particles 104, while other interstitial spaces 200 are free of such particles 104. In some examples, the particles 104 may occupy no greater than about 5%, about 10%, about 15%, about 20%, about 25%, about 30%, about 35%, about 40%, about 45%, about 50%, or any other suitable range therebetween with respect to the second total volume of the interstitial spaces 200 of the polymer region 102.

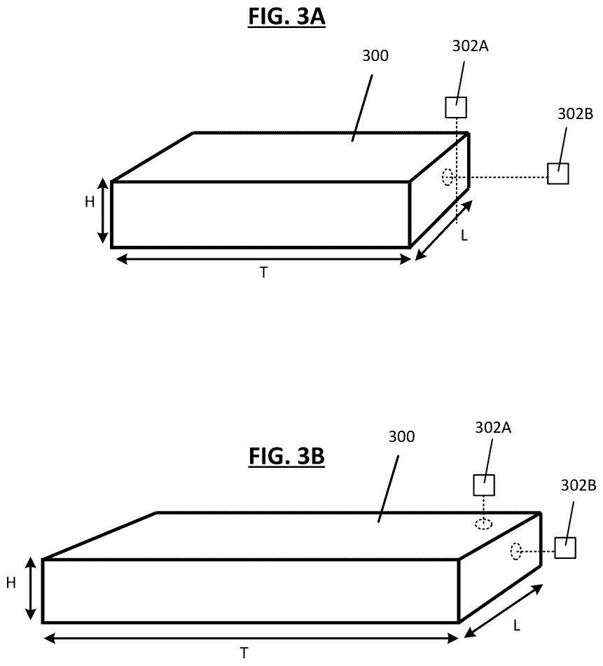

FIGS. 3A and 3B illustrate a sorbent polymer composite article 300 which may be used in for example the DAC system or carbon dioxide sorbent assembly at two different times, as further described herein. The article 300 as shown in FIG. 3A includes a first configuration with a first transverse length (T), a first longitudinal length (L), and a first total volume (V). The article 300 as shown in FIG. 3B includes a second configuration with a second transverse length (T) greater than the first transverse length, a second longitudinal length (L) that is no less than the first longitudinal length, and a second total volume (V) greater than the first total volume. A change from the first transverse length (T in FIG. 3A) to the second transverse length (T in FIG. 3B) is greater than a change from the first longitudinal length (L in FIG. 3A) to the second longitudinal length (L in FIG. 3B). The article 300 also includes a height (H) such that the total volume (V) may be calculated by multiplying the transverse length (T), the longitudinal length (L), and the height (H) together at any single time, i.e., V=T*L*H.

According to some embodiments, the article 300 in FIG. 3A has the first configuration during an adsorption process, and the article 300 in FIG. 3B has the second configuration during a desorption process. In some examples, the first longitudinal length (L in FIG. 3A) may be substantially the same as the second longitudinal length (L in FIG. 3B). In some examples, the article 300 may include at least one backer material or at least one uniaxial tape which may be weaker in a transverse direction than in a longitudinal direction, such that the swelling or expansion may occur in the transverse direction, for example.

In some examples, the article 300 is coupled with one or more sensor components 302A and/or 302B such that the sensor component(s) is capable of detecting a change in the configuration of the article 300. For example, the sensor 302A may be positioned adjacent to the article 300 such that in FIG. 3A, the sensor 302A does not detect the article 300 in the first configuration, but as the article 300 changes to the second configuration in FIG. 3B, the sensor 302A detects the article 300, thus determining that the article 300 has changed its configuration. Additionally or alternatively, the sensor 302B may be positioned in a direction substantially parallel to the transverse length (L) of the article 300 such that the sensor 302B is able to determine the distance between the sensor 302B and a nearest edge or surface of the article 300. Because the sensor 302B is in a fixed location, any decrease in the distance detected would be an indicator that the article 300 is changing its configuration.

The sensor measurements or detection may be used to control or modify the desorption process. For example, the desorption process may be controlled or modified (e.g., halted or reduced) in response to the sensor component 302A or 302B detecting that the second transverse length (T in FIG. 3B) of the article 300 exceeds a predetermined threshold, such as a predefined length as determined by the designer or manufacturer of the article 300.

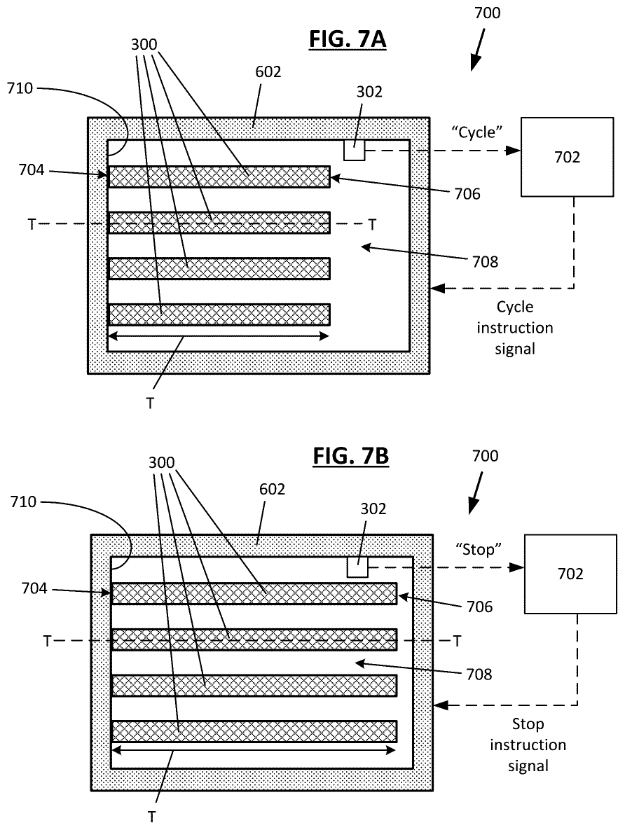

The adsorption and desorption processes may be cyclical, as explained above. In some examples, the cyclical processes including the adsorption process and the desorption process may be facilitated in response to the sensor component 302A or 302B detecting the change of the article 300 from the first transverse length (T in FIG. 3A) to the second transverse length (T in FIG. 3B). For example, the sensor 302A or 302B may take measurements, and a DAC system in which the article 300 is implemented (for example, a DAC system 700 as further described below in reference to FIGS. 7A and 7B) may use the sensor measurements to determine when to end the adsorption process and to begin the desorption process, or to end the desorption process and to begin the desorption process. In some examples, the swelling or growth of the article 300 can be controlled with respect to directionality (e.g., with respect to one axis). In some examples, the transverse direction may define an x-axis, whereas the longitudinal direction may define a y-axis or z-axis, in a 3D coordinate system. In some examples, the transverse direction may define the y-axis, whereas the longitudinal direction may define the x-axis or z-axis. In some examples, the transverse direction may define the z-axis, whereas the longitudinal direction may define the x-axis or y-axis. Sensors 302 may be applied in one or more areas to detect the dimensional change(s) of the article 300, such as in any one of the x-axis, y-axis, and z-axis as suitable, and upon detecting such changes, the sensors 302, or more specifically the controller coupled thereto, may suggest one or more operating processes.

In some examples, the primary particles or sorbent particles 104 and the sorbent polymer composite articles 300 are structured to adsorb and desorb (or capture and release) molecules such as CO₂, such as via DAC. In some examples, the sorbent particles 104 and the sorbent polymer composite articles 300 may exert hydrophobic force from within the sorbent particles in order to expel liquid water from the sorbent particles. The sorbent particles 104 and the sorbent polymer composite articles 300 may be sufficiently soft and flexible so as to facilitate expansion and compression as suitable during adsorption and desorption (or capture and release) of molecules. In some examples, the sorbent particles 104 and/or the sorbent polymer composite articles 300 may be made using or including one or more of the following materials: expanded polytetrafluoroethylene (ePTFE), polytetrafluoroethylene (PTFE), expanded polyethylene (ePE), another suitable porous polymer, or other material having an appropriate structure. In some examples, the sorbent particles 104 and the sorbent polymer composite articles 300 are made of a flexible porous polymer. It will be appreciated that non-woven materials such as nanospun, meltblown, spunbond, and porous cast films could be among the various other suitable porous polymers. The sorbent particles 104 and the sorbent polymer composite articles 300 may be expanded by stretching the polymer at a controlled temperature and a controlled stretch rate, causing the polymer to fibrillate. Following expansion, the sorbent particles may form pores or micropores through which gas may pass. Some suitable examples of node-and-fibril structures as defined in this application can be supported by the description provided in the aforementioned U.S. Pat. No. 3,953,566 assigned to W. L. Gore & Associates Inc. The pores of the sorbent particles 104 and the sorbent polymer composite articles 300 may be considered micropores. Such micropores may have a single pore size or a distribution of pore sizes. The average pores size may range from approximately 0.1 μm to 100 μm in certain embodiments.

The sorbent material used in forming the sorbent particles 104 and the sorbent polymer composite articles 300 may be a substrate having a surface configured to hold the desired substance (e.g., CO₂) from the input on the surface via adsorption. The sorbent material may vary based on which substances are targeted for adsorption. In various embodiments, the sorbent material includes a CO₂-adsorbing material which may include, but is not limited to, an ion exchange resin (e.g., a strongly basic anion exchange resin such as Dowex™ Marathon™, a resin available from Dow Chemical Company), zeolite, activated carbon, alumina, metal-organic frameworks, polyethyleneimine (PEI), or another suitable carbon dioxide adsorbing material, such as desiccant, carbon molecular sieve, carbon adsorbent, graphite, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silico-aluminophosphate, uni-polar resin, bi-polar resin, aromatic cross-linked polystyrenic matrix, brominated aromatic matrix, methacrylic ester copolymer, graphitic adsorbent, carbon fiber, carbon nanotube, nano-materials, metal salt adsorbent, perchlorate, oxalate, alkaline earth metal particle, ETS, CTS, metal oxide, chemisorbent, amine, organo-metallic reactant, hydrotalcite, silicalite, zeolitic imidazolate framework and metal organic framework (MOF) adsorbent compounds, and combinations thereof.

The sorbent material used in forming the sorbent particles 104 and the sorbent polymer composite articles 300 may be present as a coating, a filling, entrained particles, and/or in another suitable form. In some examples, the sorbent polymer composite articles 300 are formed as sheets. In some examples, the sorbent article sheets may be formed by coating any suitable sheet of material with a sorbent material such that the sorbent material forms a substantially continuous coating on the surface of the sheets or otherwise integrated with the sheets of material. Suitable sorbent coatings may be formed using any one or more of the appropriate sorbent materials as described above.

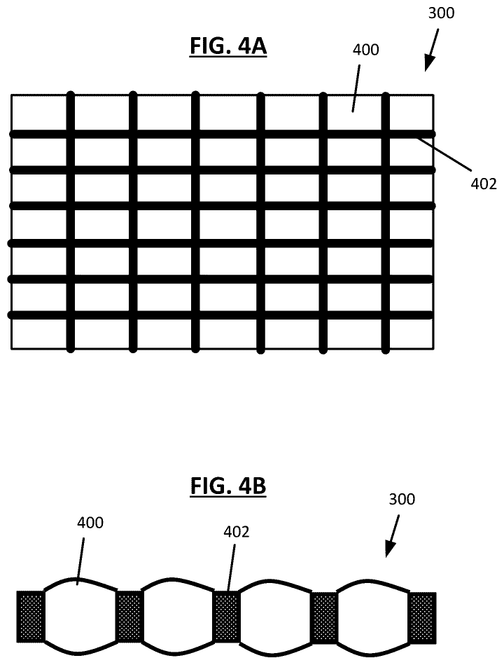

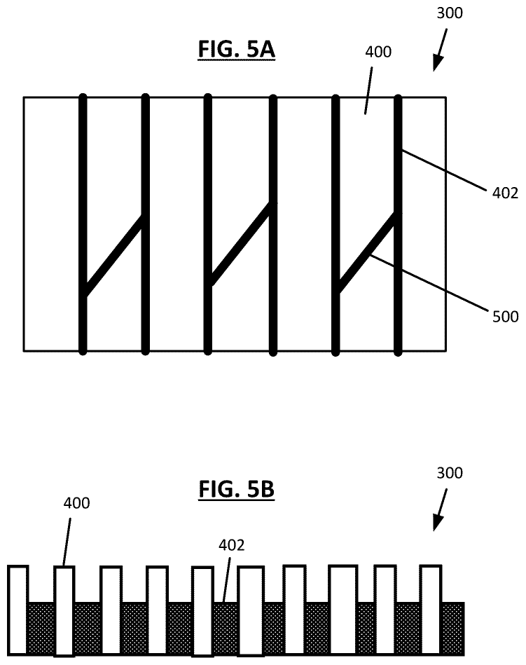

FIGS. 4A, 4B, 5A, and 5B illustrate a sorbent polymer composite article 300 which may be used in for example the DAC system or carbon dioxide sorbent, in two embodiments, each viewed from two different angles, as further described herein. The article 300 includes at least one first region 400 with a first density and a first porosity, as well as at least one second region 402 with a second density and a second porosity. The second density is greater than the first density, and the second porosity is less than the first porosity. The second region 402 is more dimensionally or structurally stable than the first region 400 due to such differences in density and porosity.

In some examples, the second region 402 is formed by compressing or densifying a base material comprising the article 300. The first region 400 and the second region 402 are formed of the same base material. In some examples, the compressing or densifying is performed using any suitable method as disclosed in, for example, U.S. Pat. No. 7,521,010 assigned to W. L. Gore & Associates Inc., incorporated herein by reference in its entirety. Examples of such compressing or densifying include but are not limited to sintering or partially melting the base material so as to form sections that are more hardened with respect to the other sections. Sintering includes subjecting the base material to a temperature above the crystalline melt temperature of the base material. The base material may include but are not limited to PTFE, ePTFE, and/or a thermoplastic material such as FEP (fluoroethylene propylene), PFA (perfluoroacrylate), or THV (a polymer of tetrafluoroethylene, hexafluoropropylene and vinylidene fluoride), for example.

As such, the first region 400 and the second region 402 may be two different alternative forms of the base material (e.g., the second region 402 being the sintered region while the first region 400 remains not sintered). In some examples, the first region 400 includes ePTFE, and the second region 402 includes PTFE, such that the base material includes both PTFE and ePTFE. In some examples, the first region 400 includes ePE and the second region 402 includes PE, such that the base material includes both PE and ePE. In some examples, the second region 402 may have a greater structural integrity or stiffness than the first region 400.

In FIGS. 4A and 4B, the second region 402 of the article 300 has a crisscross pattern on a surface of the article 300, whereas in FIGS. 5A and 5B, the second region 402 has a striped pattern on a surface of the article 300, and in some examples, the striped pattern may include a plurality of substantially parallel regions. It is to be understood that any other pattern may be implemented with regard to the second region 402, such as polygonal, sinusoidal, serpentine, hatched, random (or non-pattern), etc. In some examples, the second region 402 may have a combination of patterns such as a combination of crisscross and striped patterns on the surface of the article 300. In some examples, the striped pattern further includes a plurality of bridge regions 500 formed between neighboring parallel regions of the substantially parallel regions in the second region 402. In some examples, the first regions 400 may have a greater thickness than the second regions 402. In some examples, the first region 400 may be substantially opaque, and the second region 402 may be substantially translucent or transparent. In some examples, an opaque (or substantially opaque) region may have a light transmission percentage of from about 0% to about 10%, from about 10% to about 20%, from about 20% to about 30%, from about 30% to about 40%, from about 40% to about 50%, from about 50% to about 60%, from about 60% to about 70%, from about 70% to about 80%, or any suitable value therebetween or ranges/combination of ranges thereof. In some examples, a translucent (or substantially translucent) region may have a light transmission percentage of from about 80% to about 85%, from about 85% to about 90%, from about 90% to about 95%, or any suitable value therebetween or ranges/combination of ranges thereof. In some examples, a transparent (or substantially transparent) region may have a light transmission percentage of at or above about 95%.

In some examples, the first region 400 may have a first configuration with a first total volume during an adsorption process and has a second configuration with a second total volume greater than the first total volume during a desorption process. In some examples, a total volume of the second region 402 may remain substantially the same during the desorption process and the adsorption process.

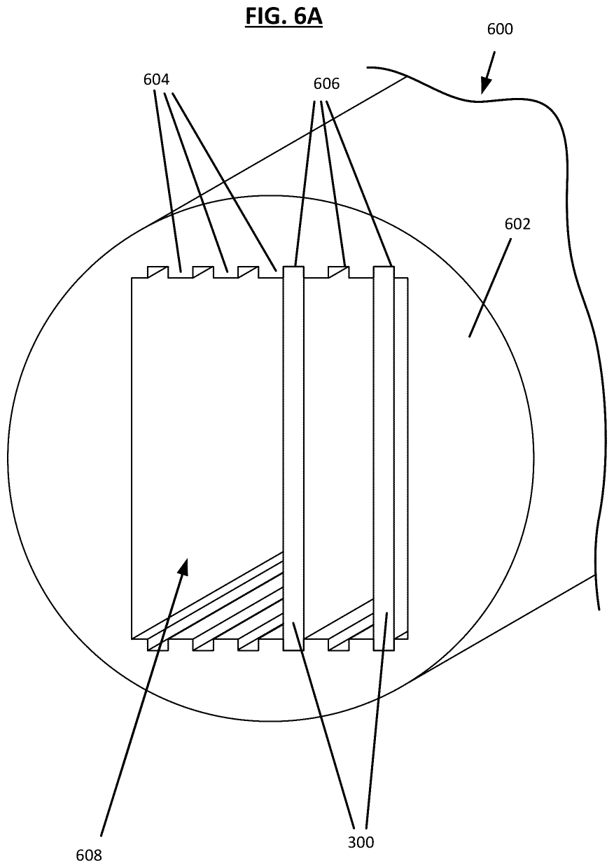

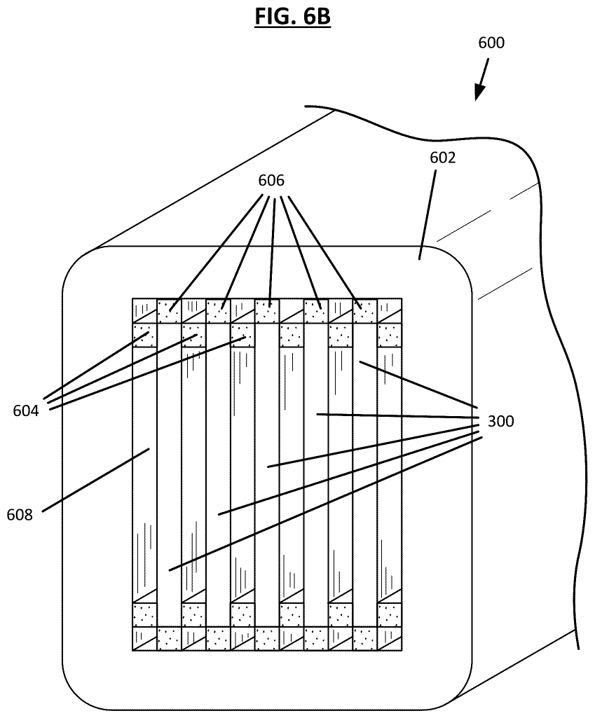

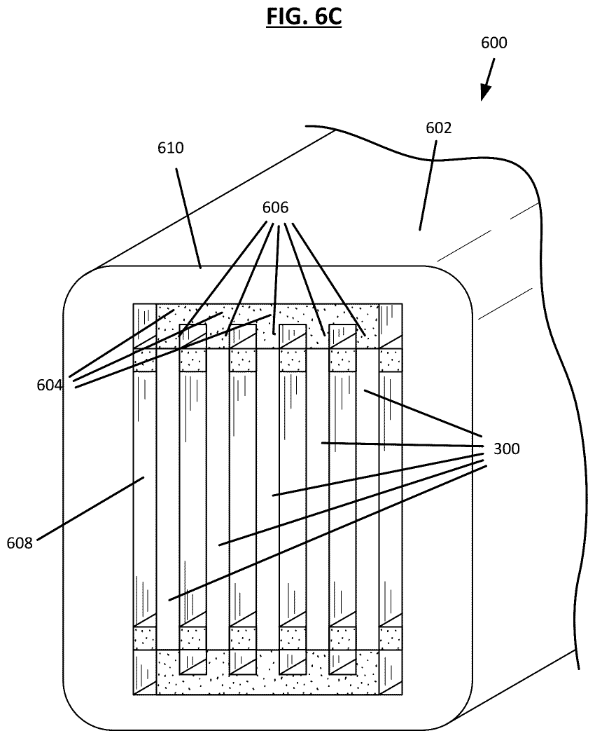

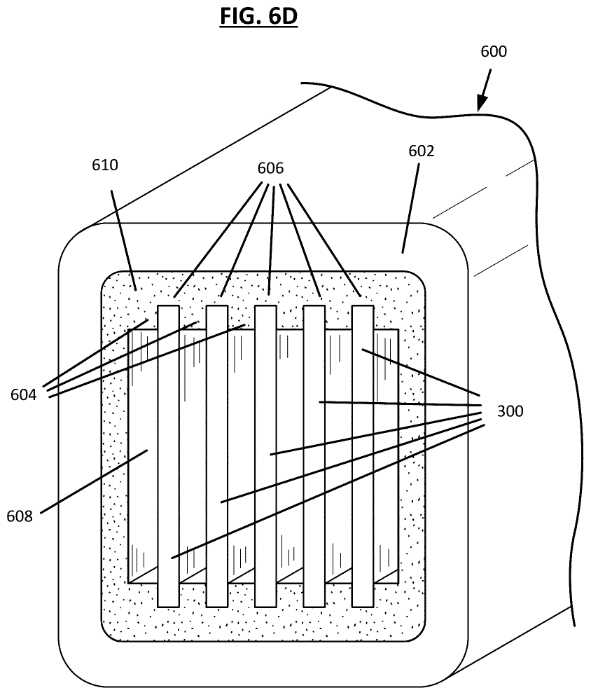

FIGS. 6A through 6D shows a sorbent polymer composite assembly 600 which may be used in for example the DAC system or carbon dioxide sorbent, in different embodiments as further described herein. The assembly 600 includes a housing 602 providing structural support and defining an inner chamber 608. The housing 602 may be compliant and flexible. The housing 602 may be modular such that it can be easily inserted into and removed from a larger system or structure. The assembly 600 includes sheets of sorbent polymer composite article (or sorbent polymer composite sheets) 300 disposed within the inner chamber 608 of the housing 602. The sorbent polymer composite sheets 300 have a first configuration with a first total volume and a second configuration with a second total volume greater than the first total volume. The assembly 600 also includes spacers 604 disposed between neighboring sheets 300 of the plurality of sorbent polymer composite sheets 300. The spacers 604 have a first configuration with a first total volume and a second configuration with a second total volume greater than the first total volume. The assembly 600 further includes gaskets 606 disposed between the sheets 300 and the inner chamber 608 of the housing 602. The gaskets 606 have a first configuration with a first total volume and a second configuration with a second total volume greater than the first total volume. The spacers 604 and the gaskets 606 have the first configuration in response to the sheets 300 having the second configuration. The spacers 604 and the gaskets 606 have the second configuration in response to the sheets 300 having the first configuration. In some examples, the spacers 604 and/or gaskets 606 may be formed using a compliant material such as a spring, foam, or foamed silicone, among others.

In FIG. 6A, the spacers 604 and the gaskets 606 are integral to the housing 602 such that the housing 602, spacers 604, and gaskets 606 are formed from a single unitary piece of material, such as a polymeric material. In FIG. 6B, the housing 602, spacers 604, and gaskets 606 are separate components, for example formed using different materials or formed using separate components of the same material. The spacers 604 and gaskets 606 may be affixed to an internal surface or internal region of the housing 602 such that the spacers 604 and gaskets 606 are disposed between the sheets 300 and the internal surface or internal region of the housing 602 as shown.

In FIG. 6C, the assembly 600 includes an insertable component 610, and the gaskets 606 are integral to the insertable component 610. The component 610 is inserted into the housing 602 to at least partially define the inner chamber 608 of the housing 602. In some examples, the component 610 is affixed to the housing 602 after being inserted into the housing 602. Thus, the spacers 604 and the component 610 are disposed between the sheets 300 and the internal surface or internal region of the housing 602 as shown. In FIG. 6D, the spacers 604 are also integral to the insertable component 610, such that the component 610 defines the spacers 604 and the gaskets 606. Thus, the component 610 is disposed between the sheets 300 and the internal surface or internal region of the housing 602 as shown.

FIGS. 7A and 7B illustrate an example of a DAC system 700 according to embodiments disclosed herein. The system 700 includes one or more of the sorbent polymer composite articles 300 as described above in view of FIGS. 3A and 3B. The sensor component 302 is implemented so as to be operatively coupled with the articles 300 and is capable of detecting the change of the articles 300 from the first transverse length (T in FIG. 7A) to the second transverse length (T in FIG. 7B). Also included in the system 700 is a controller 702 which is operatively coupled with the sensor component 302 such that the controller 702 controls an operation of the articles 300 based upon the detection by the sensor component 302. For example, the controller 702 may facilitate a cyclical process including the adsorption process and the desorption process to facilitate capturing of CO₂ from the atmosphere, for example. In some examples, the controller 702 controls or modifies the desorption process in response to the sensor component 302 detecting that the second transverse length (T in FIG. 7B) of the article 300 exceeds a predetermined threshold, such as a threshold length.

The controller 702 may be any suitable device including but not limited to a computing device (e.g., a personal computer, tablet, smartphone, or any other suitable device) having a processing unit and a memory unit, which may be any suitable type of non-transitory computer-readable medium such as random access memory, read-only memory, flash memory, or other medium, may store the data generated by the processing unit. The memory unit may also store program codes which, when run by the processing unit, causes the controller 702 to perform the controlling of the DAC process (adsorption and desorption processes).

For example, as shown in FIG. 7A, when the sensor component 302 detects that the transverse length (T) of the articles 300 is less than a predetermined length, the sensor component 302 may send the measurements to the controller 702, which the controller 702 may interpret as a “cycle” condition (that is, the condition allowing for the adsorption-desorption cycle to continue). In response, the controller 702 may send instructions to the housing 602 to continue the cycle (“cycle instruction signal”) which the housing 602 may implement accordingly. For example, the housing 602 may include a mechanism which performs the processes in response to the signal generated by the controller 702.

For example, as shown in FIG. 7B, when the sensor component 302 detects that the transverse length (T) of the articles 300 is at or greater than a predetermined length, the sensor component 302 may send the measurements to the controller 702, which the controller 702 may interpret as a “stop” condition (that is, the condition in which the adsorption-desorption cycle must stop). In response, the controller 702 may send instructions to the housing 602 to stop the cycle (“stop instruction signal”) which the housing 602 may implement accordingly. For example, the mechanism included in the housing 602 may stop the processes in response to the signal generated by the controller 702.

As explained with respect to FIGS. 3A and 3B, the change from the first transverse length (T in FIG. 7A) to the second transverse length (T in FIG. 7B) may be greater than the change from the first longitudinal length (L in FIG. 3A) to the second longitudinal length (L in FIG. 3B). In some examples, one or more of the articles 300 may be arranged or disposed in the housing 602 in a cantilever arrangement. In the cantilever arrangement, a first end 704 of the article 300 is attached to the housing 602, such as to an inner wall 710 of the housing 602 that defines a housing-defined space 708 that is made to accept the expansion or extension of the articles 300, and a second end 706 of the article 300 is a free end that remains free to expand or extend away from the first end 704 based on the change in the transverse length (T) of the article 300, such as from the first transverse length in FIG. 7A to the second transverse length in FIG. 7B, in the housing-defined space 708. The sensor 302 may be positioned within the space 708 so as to react to the expansion, such as in a transverse direction along or parallel to a transverse axis T-T of the article(s) 300. Data from the sensor 302 may be used for a variety of purposes, such as for stopping the DAC cycle before there is excessive expansion or deformation in the articles 300, for example. A plurality of articles 300 may be positioned in a parallel configuration with respect to each other such that the articles 300 are parallel to each other. The parallel configuration may be defined by the plurality of articles 300 having transverse axes T-T that are positioned to be parallel to each other.

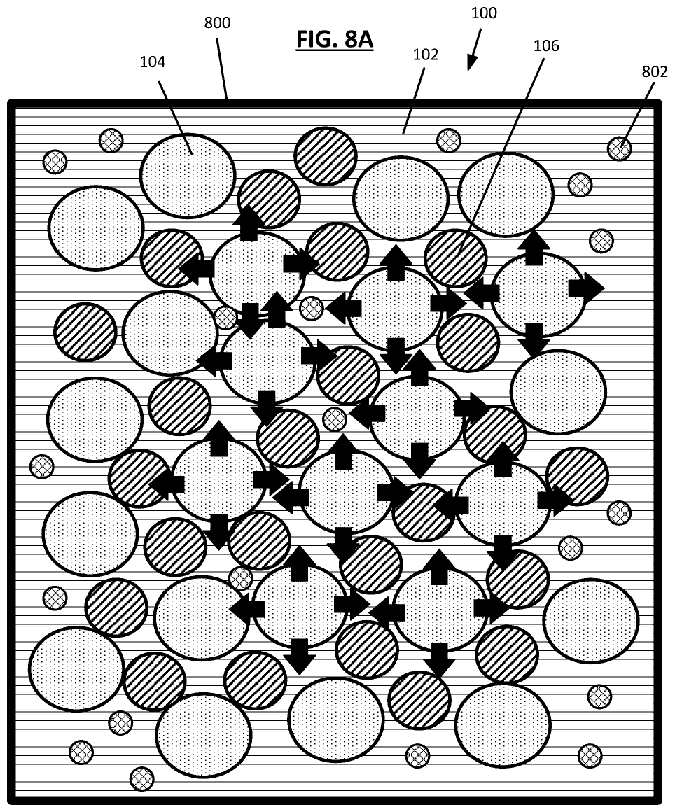

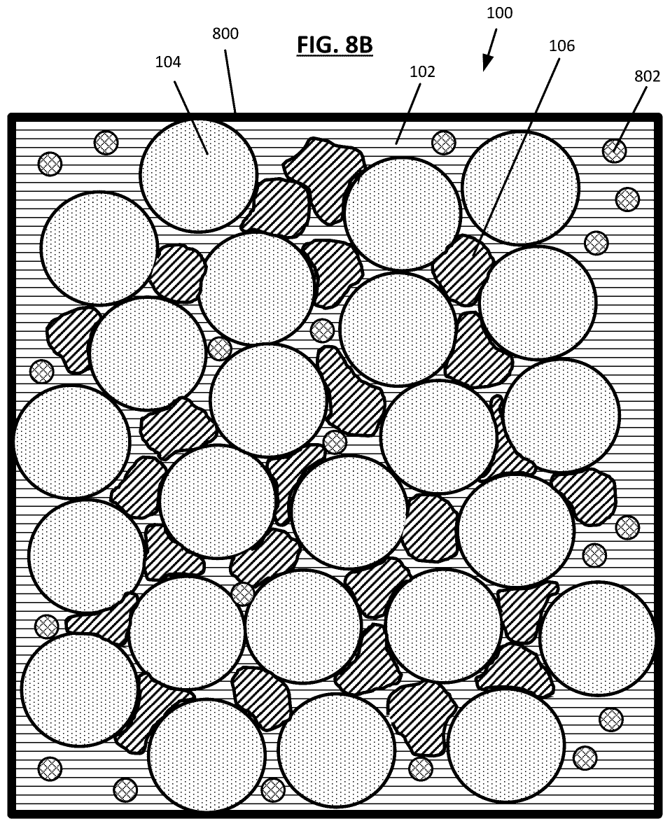

FIG. 8A illustrates the sorbent polymer composite article 100 with the polymer region 102, primary particles 104, and secondary particles 106 as further explained above. The polymer region 102 may have a constant volume as defined by an enclosure 800 in which the article 100 is disposed. For example, the article 100 may have passages (not shown) for gas access and surface area available for the carbon dioxide adsorption, as suitable. The black arrows show the possible directions in which the swelling, expanding, or enlarging of the primary particles 104 may take place. As shown in FIG. 8B, when the primary particles 104 swell, expand, or enlarge, for example via hydration, the secondary particles 106 are deformed or compressed to minimize ingress passageways and cover the surface area of the primary particles 104. Such action may be used for self-regulation of the water adsorption by the particles 106, for example. The enclosure 800 may be a three-dimensional boundary which may include, but are not limited to, the 3D matrix of the ePTFE, and/or the filaments of a nonwoven material such as a meltblown or spunbond material, as explained above. The secondary particles 106 may be designed to absorb the force of the swelling, expanding, or enlarging of the primary particles 104, and in some examples also to absorb any damage to the substrate (e.g., polymer region 102) that the particles are contained within. Although only a cross-sectional view is shown in FIGS. 8A and 8B, it should be understood that the secondary particles 106 may three-dimensionally cover the outer surface of the primary particles 104 so as to facilitate the aforementioned actions.

In some examples, the sorbent polymer composite article 100 may additionally include structurally stable particles 802 which are more structurally stable than both the primary particles 104 and the secondary particles 106. In some examples, the particles 802 may retain their original state or configuration in both FIGS. 8A and 8B as shown. As such, the structurally stable particles 802 may be made of a solid, rigid, or noncompliant material. In some examples, the particles 802 may have one or more functionalities, such as: protecting sorbent material of the article from liquid water, protecting sorbent material of the article from oxidation, and/or efficiently heating sorbent material of the article using heating (including but not limited to electric heating, e.g., high frequency heating and power frequency heating, such as induction heating, resistance heating, dielectric heating, electric arc heating, etc.) for example. When protecting sorbent material of the article from liquid water, the particles 802 may be made of any one or more suitable materials including but not limited to desiccants and hydrogels. When protecting sorbent material of the article from oxidation, the particles 802 may be made of any one or more suitable materials including but not limited to oxygen scavenging materials such as iron and any suitable salt such as sodium chloride. When efficiently heating sorbent material of the article, the particles 802 may be made of any one or more suitable materials including but not limited to metallic particles (e.g., iron or aluminum), ceramic particles, and graphite particles. The particles may be provided in coarse or fine powdered form. It is understood that the particles 104, 106, and 802 may be distributed homogeneously throughout the article 100 or non-homogeneously such that different portions or regions of the article 100 may include different levels of distribution of such particles (e.g., with varying ratios or concentrations of different particles).

In some examples, the structurally stable particles 802 may be considered an additive to the article 100 with primary particles 104 and secondary particles 106 so as to improve certain properties of the article 100. Such properties may include, but are not limited to: protection against water or humidity being contained within the article 100, protection against oxidation of the article 100, and/or inductive heating capabilities. To achieve such properties, the structurally stable particles 802 may be a mixture of particles that are chosen to include a combination of one or more of: ceramic particles, metal particles, or graphite particles, for example. In some examples, the particles 802 may include zeolite powders or particles to provide a desiccant for the article 100. The particles 802 may occupy a portion of the volume defined by the article 100 and/or internal pores or spaces thereof (e.g., the interstitial spaces 200 shown in FIGS. 2A and 2B). In some examples, the total volume occupied by the particles 802 may be no more than 20%, no more than 15%, no more than 10%, no more than 5%, or any other range therebetween with respect to the total volume of the article 100.

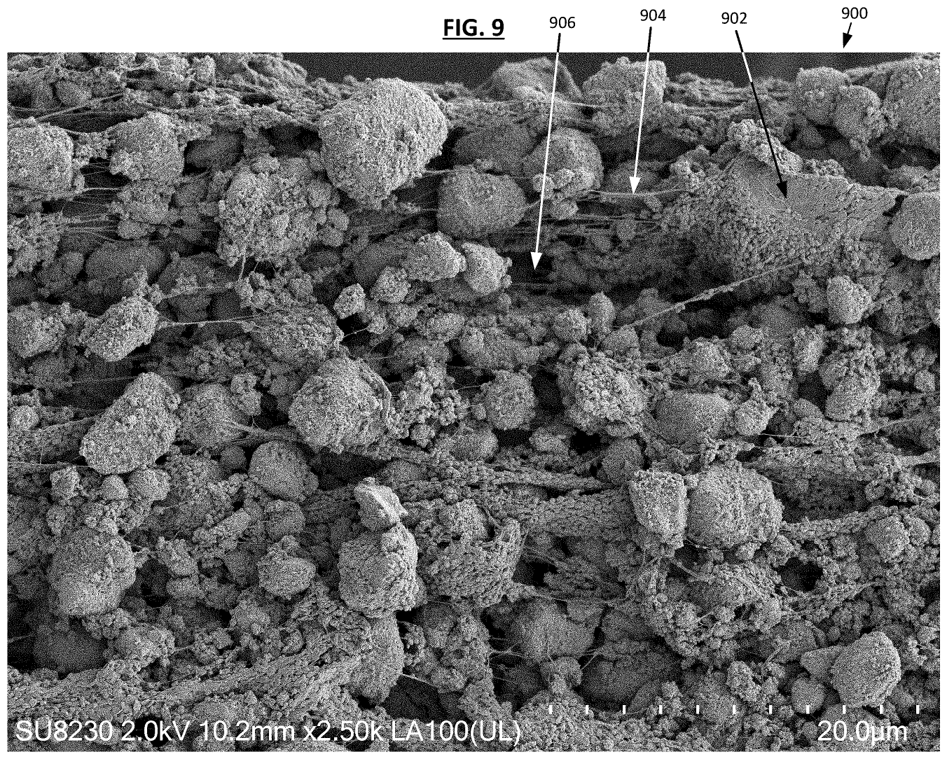

FIG. 9 is an SEM image of a polymeric material 900 such as ePTFE which may be used as the particles as disclosed according to embodiments disclosed herein. Displayed at the bottom of the image is: “SU8230 2.0 kV 10.2 mm×2.50 k LA100(UL)” and the distance between two consecutive lines as shown at the bottom right hand corner represents 2.0 μm. Shown are a plurality of nodes 902 and fibrils 904 formed using the material 900, as well as a plurality of interstitial spaces 906 that is not occupied by the nodes and fibrils. In some examples, the image is representative of a product where a portion or all of the particles as shown are either structurally stable particles or expandable particles, or a combination of both types of particles. In some examples, the material 900 may constitute the polymer region 102, and the nodes 902 and fibrils 904 form the 3D matrix (or microstructure) of the polymer region 102 (which may be ePTFE), such that the primary particles 104 may be introduced and expanded into the interstitial spaces or gaps 906 (which may be similar to the interstitial spaces 200 in the polymer region 102) as shown in FIGS. 2A and 2B. In some examples, the nodes 902 and fibrils 904 may represent the primary particles 104 which may expand into the interstitial spaces 906. In some examples, the nodes 902 may have various different sizes, for example having a calculated standard deviation value (σ) of at least 2 μm, at least 3 μm, at least 5 μm, at least 7 μm, at least 10 μm, or any other suitable value or range therebetween with respect to a mean or average particle size, for example. In some examples, the size of the largest node 902 may be at least 2 times, at least 3 times, at least 4 times, at least 5 times, at least 10 times, at least 20 times, at least 30 times, at least 40 times, at least 50 times, or any other suitable value or range therebetween with respect to the size of the smallest node 902 as measured.

In some examples, a first portion of the particles or nodes 902 is expandable, and a second portion thereof is structurally stable (that is, not compressible or expandable) such that when the first portion with the expandable particles expands, the expansion causes a force to be applied to the spaces or gaps 906 and to the second portion with the stable particles. In some examples, the force pushes the second portion with the stable particles into some of the spaces or gaps 906. In some examples, a first portion of the particles or nodes 902 is expandable, and a second portion thereof is compressible, such that when the first portion expands, the expansion force imparted thereby may be at least partially absorbed by the second portion that is compressible. In some examples, a first portion of the particles or nodes 902 is expandable, a second portion thereof is compressible, and a third portion thereof is structurally stable, such that when the first portion expands, some of the expansion force imparted thereby may be at least partially absorbed by the second portion that is compressible, and the remaining expansion force may cause the second portion and/or third portion into some of the spaces or gaps 906.

In some examples, a total volume, shape, or structure of the material 900 may remain stable or consistent throughout the expansion of the expandable particles (e.g., the first portion of the particles or nodes 902). In some examples, the expansion of the expandable particles (e.g., the first portion of the particles or nodes 902) may direct the expansion of the total structure in a predetermined direction, for example as shown in FIGS. 3A and 3B. In some examples, there may be an orientation or directional bias in the way that the material 900 is stretched or pulled in a certain direction. For example, as shown in FIG. 9, the fibrils 904 may generally be positioned in a predetermined orientation, for example in a sideways or longitudinal direction, as measurable via the orientation of the fibrils 904. In some examples, the material 900 may comprise a homogeneous mixture of particles. In some examples, a portion of the nodes 902 may be composed of a different material from the other nodes, such that there is a non-homogeneous mixture of particles. The different materials forming the different nodes 902 may cause the nodes to have different physical properties from each other (e.g., causing some to be more expandable, compressible, or structurally stable than others).

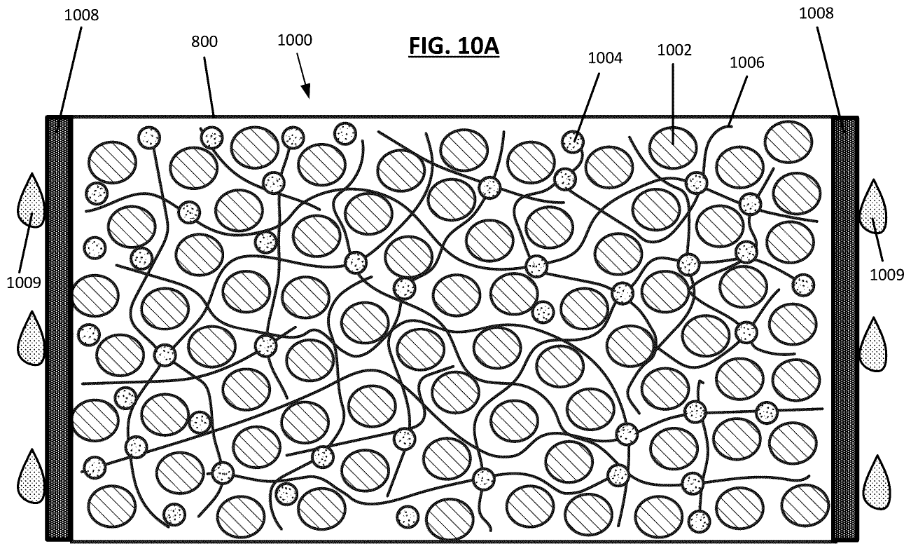

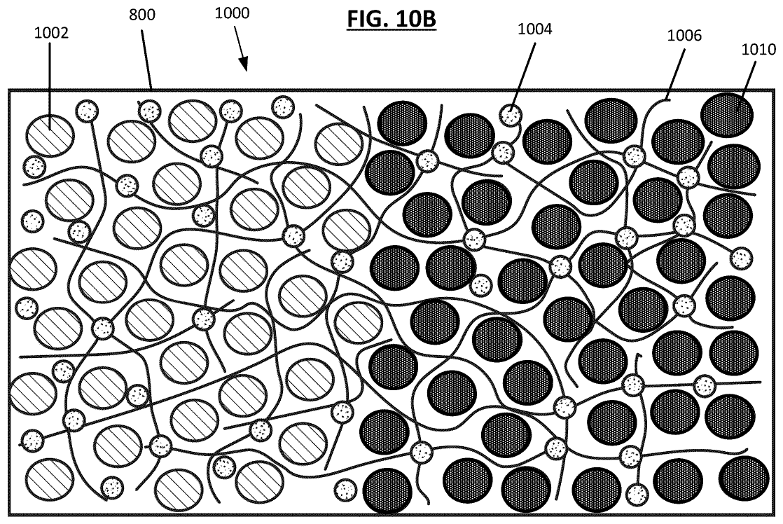

FIG. 10A shows a mixture-based sorbent article 1000 according to some embodiments which includes a mixture of particles 1002 and 1004 (and in some examples, also filaments 1006) inside the enclosure 800. The particles 1002 and 1004 may have different shapes or sizes and may be made of different materials. For example, the particles 1002 (which may be the larger particles) may be the sorbent particles, and the particles 1004 (which may be the smaller particles) may be the additive particles. As shown, the particles 1002 and 1004 may be mixed together, for example in an intermixed distribution. In some examples, the additive particles may at least partially include a plurality of particles made of a hydrophobic material (that is, hydrophobic particles) that exert hydrophobic force (for example, outwardly) to expel liquid water from the sorbent article 1000. In some examples, the hydrophobic force may be exerted against liquid water located on a surface of the article 1000 to reduce the amount of liquid water entering the article 1000.

In some examples, the particles 1004 and filaments 1006 may collectively form a network that is defined by the shapes and positions of such particles and filaments. The particles 1004 of such network may or may not be connected to each other. The particles and filaments as shown may either be connected or be merely overlapping with each other within the three-dimensional space of the enclosure 800. The three-dimensional network of particles and filaments, in some examples, may define a plurality of interstitial spaces in which the particles 1002 may be located. In some examples, the article 1000 may be devoid of any filaments 1006 such that the particles 1002 and 1004 are allowed to move freely within the enclosure 800.

In some examples, the enclosure or container 800 may include one or more hydrophobic layer(s) 1008 disposed adjacent to the article 1000. As shown, there may be two such hydrophobic layers 1008 such that the particles 1002 and 1004 (as well as filaments 1006) are disposed between the two porous hydrophobic layers 1008. In some examples, the hydrophobic layer 1008 has a first permeability with respect to water vapor that is greater than a second permeability with respect to liquid water, such that liquid water is formed as result of condensation of the water vapor within the article 1000. In some examples, the hydrophobic layer 1008 is impermeable with respect to the liquid water under atmospheric pressure. In some examples, the hydrophobicity of the particles 1002 and/or 1004 may cause sufficient hydrophobic force to be exerted, causing liquid water to be expelled outwardly through the hydrophobic layer 1008. As shown, liquid water 1009 is located on the outwardly facing surface of the hydrophobic layers 1008 (that is, the surface of the hydrophobic layers 1008 located opposite from the particles 1002 and 1004) after being expelled from inside the article 1000. The expelled liquid water 1009 may then be collected and recycled/reused as suitable.

FIG. 10B shows the mixture-based sorbent article 1000 according to some embodiments which includes a mixture of particles 1002, 1004, and 1010 (and in some examples, also filaments 1006) inside the enclosure 800. The particles 1002 and 1010 may be different forms or types of sorbent particles, or the particles 1004 and 1010 may be different forms of additive particles. In some examples, the particles 1010 may be referred to as sorbent particles, and in some examples, the particles 1010 may be referred to as additive particles. In some examples, the particles 1010 may be additive particles, similar to the additive particles 1004, but with different sizes (e.g., larger than the particles 1004) or made of different materials.

As disclosed herein, the hydrophobic particles may be made using one or more of ePTFE, PTFE, ePE, another suitable porous polymer, or other material having an appropriate structure. In various embodiments, the hydrophobic particles are made of a flexible porous polymer. It will be appreciated that non-woven materials such as nanospun, meltblown, spunbond, and porous cast films could be among the various other suitable porous polymers. The hydrophobic particles may be expanded by stretching the polymer at a controlled temperature and a controlled stretch rate, causing the polymer to fibrillate. Following expansion, the hydrophobic particles may comprise a structure of a plurality of nodes and a plurality of fibrils that connect adjacent nodes. In these instances, the hydrophobic particles may include pores. Some suitable examples of node-and-fibril structures as defined in this application can be supported by the description provided in U.S. Pat. No. 3,953,566 assigned to W. L. Gore & Associates, Inc. The pores of the hydrophobic particles may be considered micropores. Such micropores may have a single pore size or a distribution of pore sizes. The average pores size may range from approximately 0.1 micron to 100 microns in certain embodiments. The hydrophobic layers 1008 may be made of the same or similar material as the hydrophobic particles.

As used herein, the sorbent particles are structured to adsorb and desorb (or capture and release) molecules such as CO₂, such as via direct air capture (DAC), and in some examples also exert hydrophobic force from within the sorbent article in order to expel liquid water from the sorbent article. The sorbent particles may be of any suitable shape, including but not limited to, spherical, polyhedral, or irregular shapes according to the method of how the sorbent particles may be manufactured. In some examples, the sorbent particles are sufficiently soft and flexible so as to facilitate movement of the particles within the casing to facilitate adsorption and desorption (or capture and release) of molecules. It is also within the scope of the present disclosure for at least some of the additive particles to be filled with the sorbent material such that the sorbent material is incorporated into the nodes and/or fibrils of the structure. In some examples, the additive particles may be referred to as “powders” due to the small size of each particle.

The placement of the additive particles and sorbent particles may be random, such as in a homogeneous mixture based upon weights of the various components. In some examples, the placement may be precisely engineered (or the sorbent particles and the hydrophobic particles are in a predefined placement with respect to each other) so as to cause hydrophobic forces to be greater in some areas. This may allow the hydrophobic forces to cause any liquid water to move in a defined direction (such as toward a drain point). Precise and repeatable placement may be achieved by methods such as used in 3-D printing, where nozzles may deposit particles in specific amounts to specific areas within a volume, or by other deposition techniques as appropriate.

The fibrils and nodes can be defined in terms of the length-to-width ratio thereof. The length may be defined as the longest dimension of the object being measured, and the width may be defined as the shortest dimension of the object being measured. For example, the fibrils may have a length-to-width ratio that is greater than the length-to-width ratio of the nodes. In some examples, the nodes have a relatively round shape, or a shape with the length-to-width ratio closer to 1, such as approximately from 1.0 to 1.5, from 1.5 to 2.0, from 2.0 to 2.5, from 2.5 to 3.0, or any other value therebetween or combination thereof. In contrast, the fibrils, in some examples, may have the length-to-width ratio greater than approximately 10, 20, 30, 40, 50, or any other value or range therebetween, indicating a much more elongated configuration than the nodes.

The sorbent particles and the additive particles may differ from each other in that they have different levels of hydrophobicity; the additive particles may have a first hydrophobicity and the sorbent particles may have a second hydrophobicity different from the first hydrophobicity. For example, the sorbent particles may be characterized by a lower hydrophobicity compared to the additive particles. In some examples, the sorbent particles are hydrophilic (that is, non-hydrophobic) or partially/temporarily hydrophobic (parts thereof may have hydrophobicity). The sorbent particles and the additive particles may be shown as separate and disconnected from each other to form the sorbent article 1000. In some examples, the elements of the sorbent particles may be described as free-floating or mobile with respect to other elements of the article.

In some examples, the structure (such as the node-and-fibril structure) is at least partially contained within the enclosure 800 and is structured to facilitate restricting the movement of hydrophobic elements (that is, a portion of the additive particles) with respect to the sorbent particles, in order to maintain a distribution (such as a mixture or an intermixed distribution) of the sorbent particles and the additive particles. The enclosure 800 may be further configured to maintain the sorbent particles and the additive particles in an intermixed distribution. In some examples, the sorbent particles are discrete and loosely packed within the enclosure 800. In some examples, the additive particles are also discrete and loosely packed within the enclosure 800.

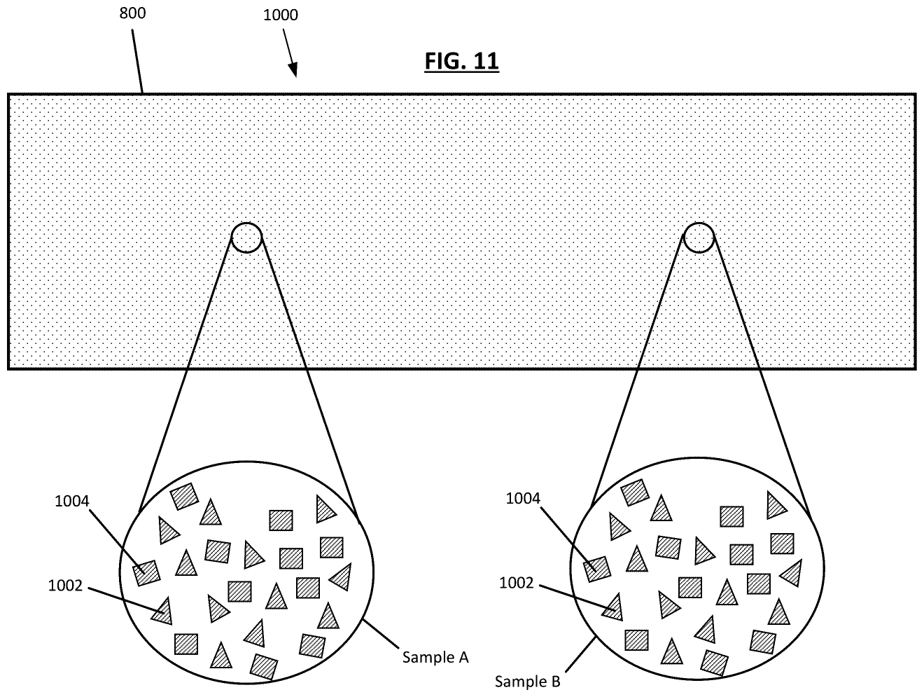

FIG. 11 shows a mixture-based sorbent article 1000 according to some embodiments which includes a homogeneous mixture of particles 1002 and 1004 inside the enclosure 800. That is, in both Sample A and Sample B (each showing an expanded view of a portion of the article 100 within the enclosure 800) the concentration of the particles 1002 and 1004 are same, substantially the same, or similar. In some examples, the difference between the concentrations measured in Samples A and B may be no greater than 5%, no greater than 3%, no greater than 1%, or any other suitable range therebetween.

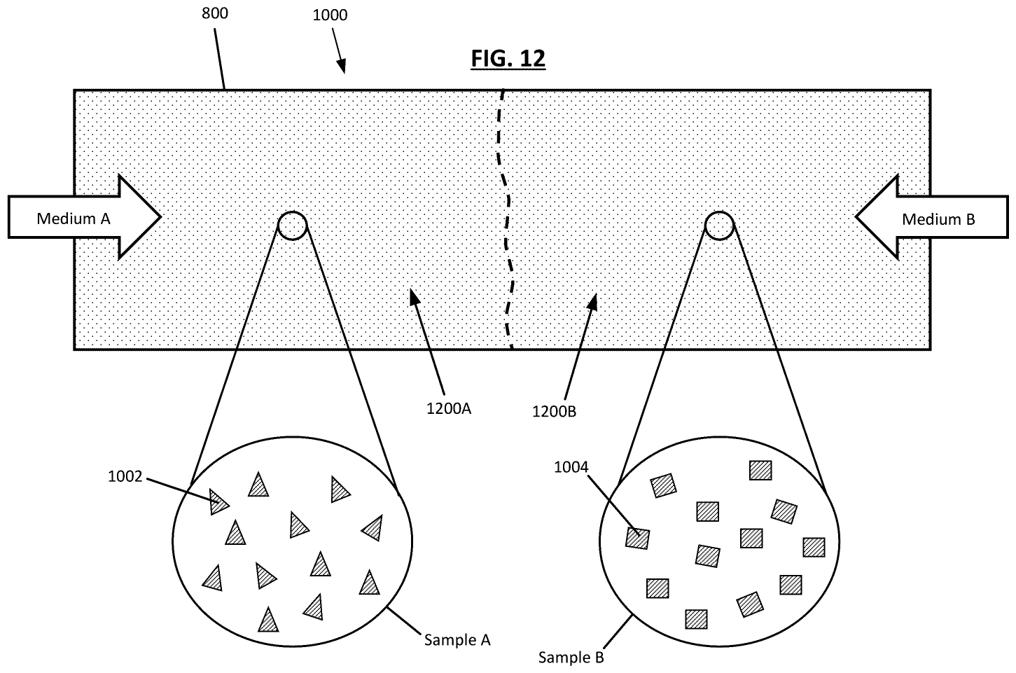

FIG. 12 shows a mixture-based sorbent article 1000 according to some embodiments which includes a non-homogeneous mixture of particles 1002 and 1004 inside the enclosure 800. That is, in a first region 1200A shown by Sample A, there may be a greater concentration of the particles 1002 than the particles 1004, and in the second region 1200B shown by Sample B, there may be a greater concentration of the particles 1004 than the particles 1002. In some examples, the difference between the concentrations measured in Samples A and B may be no less than 50%, no less than 55%, no less than 60%, no less than 65%, no less than 70%, no less than 75%, no less than 80%, no less than 85%, no less than 90%, or any other suitable range therebetween. In some examples, the regions 1200A and 1200B are configured to receive different types of medium. For example, the first region 1200A may receive medium A which may be air (e.g., an airflow inlet may be installed on the enclosure 800 to facilitate such flow of air into the article 1000), and the second region 1200B may receive medium B which may be steam (e.g., a steam flow inlet may be installed on the enclosure 800 to facilitate such flow of steam into the article 1000). In some examples, the particles 1002 and 1004 may be different forms or types of sorbent particles and may include different forms or types of additive particles. Although the broken line shows an imaginary divider between the two regions 1200A and 1200B as an example, it is to be understood that in some examples there may be no physical divider between these regions, or that the regions may gradually shift in concentration from one region to another such that there is no clear boundary (e.g., linear boundary) between the two regions. In such examples, the shift in concentration from one region to another may be illustrated as a gradual concentration gradient.

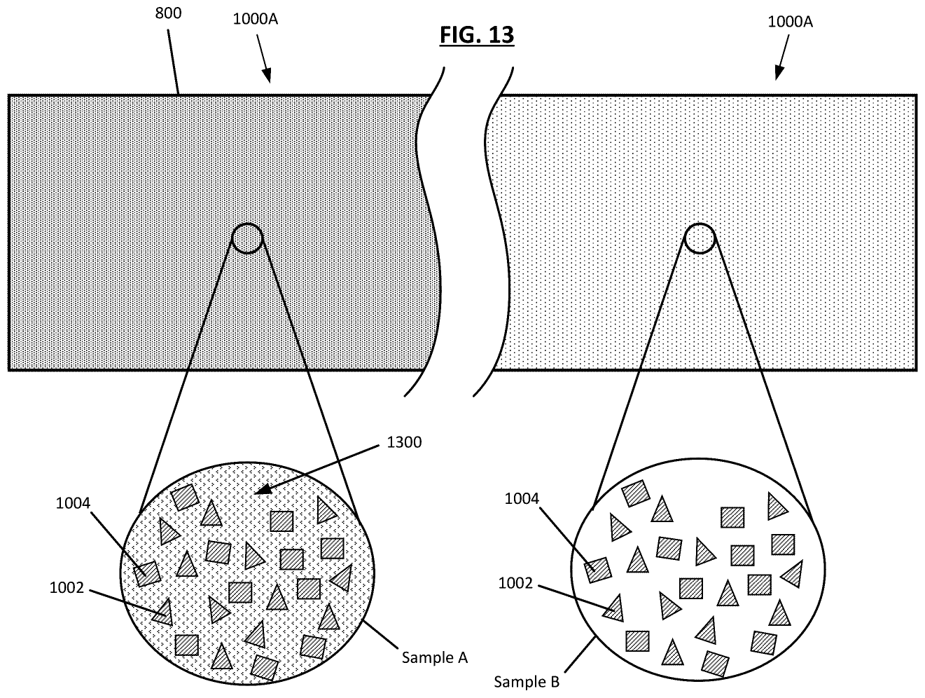

FIG. 13 shows a mixture-based sorbent article 1000 according to some embodiments which includes a homogeneous mixture of particles 1002 and 1004 inside the enclosure 800 at two different times. The article 1000A at an earlier time may include, in addition to the particles 1002 and 1004, one or more temporary binders 1300 as shown in Sample A, which may produce a sufficiently stiff composite for the article 1000A to be handled manually. At a later time, the article 1000B may only include the particles 1002 and 1004 after the temporary binder 1300 is removed as shown in Sample B. In some examples, the binder 1300 may be dissolvable under certain conditions such as being subjected to a certain type of liquid which is capable of dissolving the binder 1300. For example, the binder 1300 may be starch, and the liquid may be water which is used to wash the starch out of the article 1000 while the particles 1002 and 1004 remain within the article 1000 (for example, within the matrix of the article 1000 as defined by the filaments 1006, within the matrix of an ePTFE construct, or within a meltblown or spunbond substrate). The removal or dissipation of the binder 1300 may cause the formation of voids or spaces within the matrix of the article 1000 such as within the polymer region 102. In some examples, the material of the binder 1300 may partially remain within the article 1000 at a later time, such as in the article 1000B shown in Sample B, as a residual of the original binder 1300 that was placed there.

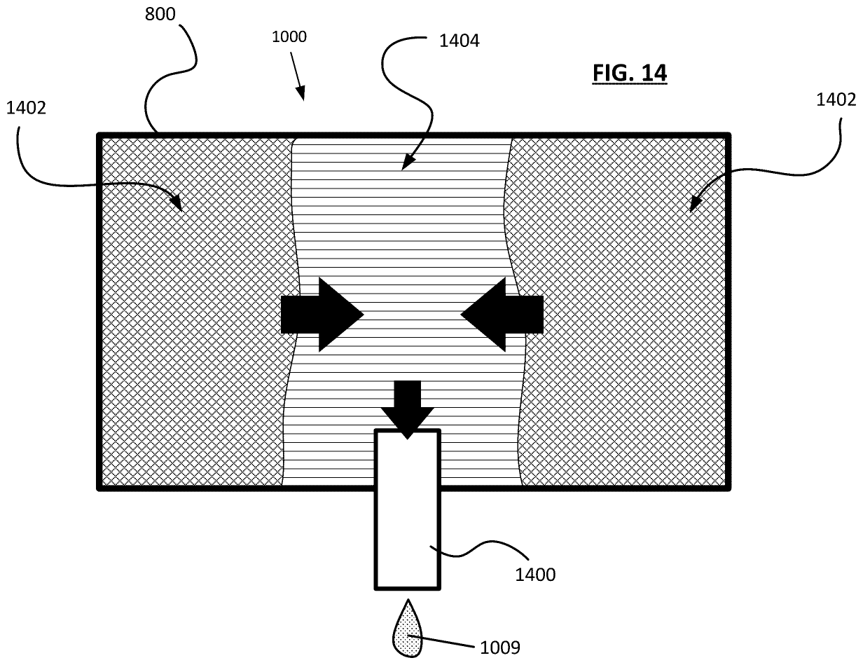

FIG. 14 shows an embodiment of the sorbent article 1000 according to examples of the present disclosure. The sorbent article 1000, in some examples, may be stored or at least partially confined within the enclosure 800 such as a casing or other type of container, where the enclosure 800 may also include a drain 1400 which is a conduit extending through the enclosure 800 connecting the inside of the enclosure with the outside. The internal mixture may contain discrete and loosely packed particles as disclosed herein. The sorbent article 1000 is arranged such that there is an area or region 1404 of lower hydrophobicity surrounded by areas or regions 1402 of higher hydrophobicity. The difference in hydrophobicity may be controlled by varying the amount or type of additive particles that are included in certain regions of the article 1000.

As shown by the centrally-pointing arrows, the hydrophobic forces from the regions 1402 where greater hydrophobicity exists push any water droplet which may form within the sorbent article 1000 (that is, liquid water formed as a result of condensation of any water vapor which remained within the sorbent article 1000) toward the region 1404 therebetween where the hydrophobicity is lower (which, in some examples, may even be hydrophilic). The water droplets collected within the region 1404 are pulled downward by gravitational force, as shown by the downward-pointing arrow, and subsequently purged or expelled from the inside of the enclosure 800 through the drain 1400. The expelled water (e.g., water 1009) in some examples may be collected using a water collection tool such as a tank or tube (not shown) and thereafter reused or recycled.

The inclusion of additive materials as additive particles include numerous different benefits as explained herein. In some examples, separating the sorbent material with another different material (e.g., using a spacer) may allow CO₂ to better access the sorbent article during adsorption and desorption cycles. The additive particles 1004 may include any of the materials as disclosed herein with respect to the structurally stable particles 802. As such, the additive materials may include desiccants or hydrogels to protect the sorbent particles from liquid water, oxygen scavenging materials such as iron to protect the sorbent particles from oxidation, and/or metal such as iron to facilitate efficient heating of the sorbent particles. In some examples, graphite particles may be added as a flow enhancer to enhance the flow of media through the article. In some examples, PTFE particles or ePTFE particles may be added to increase hydrophobicity. In some examples, zeolite particles may be added as desiccant. In some examples, polystyrene particles may be added to absorb swelling of the sorbent particles. In some examples, aluminum particles may be added to improve the heating capability. In some examples, hydrogel particles may be included to act as water wick for the article.

In some examples, the sorbent particles may occupy at least 80%, at least 85%, at least 90%, at least 95%, or any other suitable range therebetween of a total volume of the sorbent polymer mixture or of the article 1000, and the additive particles may occupy no greater than 20%, no greater than 15%, no greater than 10%, no greater than 5%, or any other suitable range therebetween of the total volume of the sorbent polymer mixture or of the article 1000. For example, there may be a plurality of different types of additive particles as disclosed herein that are implemented in the article 1000 in any one of a plurality of combinations. In some examples, of the total volume occupied by the additive particles, from 50% to 60%, from 60% to 70%, from 70% to 80%, or any suitable range therebetween may comprise the heating element particles such as aluminum particles, and from 10% to 20%, from 20% to 30%, or any other suitable range therebetween of the total volume occupied by the additive particles may comprise flow enhancer particles such as graphite particles, and from 10% to 20% from 20% to 30%, or any other suitable range therebetween of the total volume occupied by the additive particles may comprise hydrophobic particles such as PTFE or ePTFE particles.

In some examples, the composition of the article 1000 may vary depending on the geographic location and/or the season in which the article 1000 is to be in operation. For example, for a more humid location or season, the article 1000 may implement a greater amount of desiccant material as the additive particles than would be implemented for a drier location or season. For example, for a colder location or season, the article 1000 may implement a greater amount of metallic particles as the additive particles to facilitate inductive heating than would be implemented for a hotter location or season.

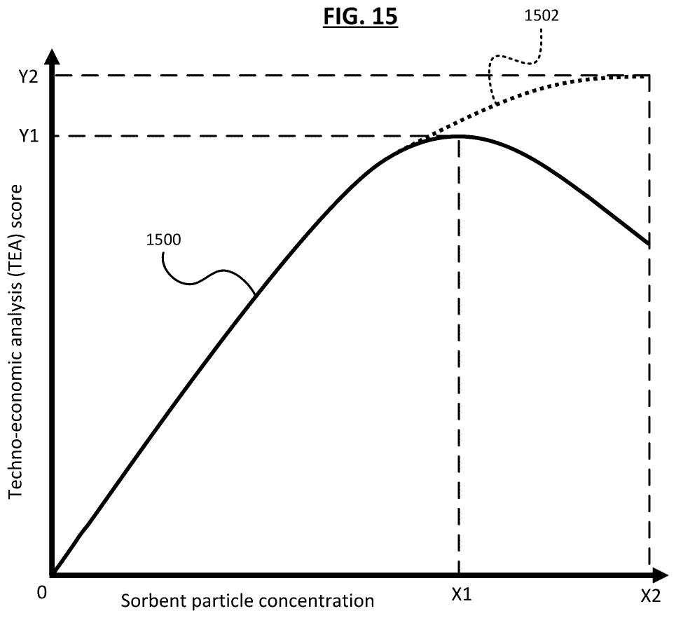

FIG. 15 shows a graph depicting the change in techno-economic analysis (TEA) score of a sorbent article in view of the amount of sorbent in a predetermined volume or in view of the concentration of the sorbent in the sorbent article. As known in the art, TEA score is calculated based on the different components or substances implemented in the sorbent article, and the TEA score takes into consideration the resulting effects or properties of the sorbent article including but not limited to, for example, cost of manufacture, operation capacity, life cycle expectancy, and kinetics of adsorption/desorption process performed by the sorbent article. In some examples, the TEA score is determined using methods and algorithms as disclosed in, for example, the following documents:
Fasihi, M., Efimova, O., & Breyer, C. (2019). “Techno-economic assessment of CO₂ direct air capture plants.” Journal of Cleaner Production, 224, 957-980. https://doi.org/10.1016/j.jclepro.2019.03.086, hereinafter referred to as the “Fasihi paper”
Keith, D. W., Holmes, G., St. Angelo, D., & Heidel, K. (2018). “A process for capturing CO₂ from the atmosphere.” Joule, 2(8), 1573-1594. https://doi.org/10.1016/j.joule.2018.05.006
Azarabadi, H., & Lackner, K. S. (2019). “A sorbent-focused techno-economic analysis of direct air capture.” Applied Energy, 250, 959-975. https://doi.org/10.1016/j.apenergy.2019.04.012, hereinafter referred to as the “Azarabadi paper”

As explained in the aforementioned Fasihi paper, the TEA takes into consideration the economic estimations (e.g., cost per “total CO₂” or “tCO₂” that is captured) of the different DAC configurations, in addition to the technical parameters. The TEA score may include, for example, the levelized cost of electricity (LCOE), the levelized cost of heat (LCOH), and the levelized cost of CO₂ DAC (LCOD). Each of the levelized costs may be calculated using equations such as those shown below:

$$LCOE = \frac{Capex \cdot crf + {Opex}_{fix}}{FLh} + {Opex}_{var} + \frac{fuel}{η} \qquad ( Equation l )$$

$$LCOH = \frac{Capex \cdot crf + {Opex}_{fix}}{FLh} + {Opex}_{var} + \frac{fuel}{η} + \frac{LCOE}{COP} \qquad ( Equation 2 )$$

$$LCOD = \frac{{Capex}_{DAC} \cdot crf + {Opex}_{fix}}{{Output}_{{CO}_{2}}} + {Opex}_{var} + {DAC}_{el . input} \cdot LCOE + {DAC}_{th . input} \cdot LCOH \qquad ( Equation 3 )$$

$$crf = \frac{WACC \cdot {( 1 + WACC )}^{N}}{{( 1 + WACC )}^{N} - 1} \qquad ( Equation 4 )$$

where “Capex” stands for “capital expenditures”, “crf” stands for “annuity factor”, “Opex” stands for “annual operational expenditures”, “fix” stands for “fixed”, “var” stands for “variable”, “Output_{CO2}” stands for “annual CO₂ production of DAC plant”, “FLh” stands for “full load hours per year”, “DAC_{el.input}” stands for “electricity demand of DAC plant per tCO₂ produced”, “DAC_{heat.input}” stands for “heat demand of DAC plant per tCO₂ produced”, “fuel” stands for “fuel costs”, “n” stands for “efficiency”, “COP” stands for “coefficient of performance of heat pumps”, “WACC” stands for “weighted average cost of capital”, and “N” stands for “lifetime”.

Furthermore, as explained in the Azarabadi paper, the TEA score may also include cost calculations based on one lifetime of the sorbent (t_{life}). For example, Equation 5 below may be used to the net present value (NPV₀) of a DAC system as calculated for a single sorbent lifetime (t_{life}):

$$N P {V}_{0} = {N}_{r e v} - ( {N}_{O \& M} + {N}_{B o P} + {N}_{S} ) \qquad ( Equation 5 )$$

where Nᵣₑᵥ is the net present value of the revenue generated from selling CO₂ during the operation of the device. N_{O&M} stands for the costs discounted to present time for operation and maintenance, N_{BoP} stands for the balance of the plant, and Nₑ stands for the sorbent. For a business to be profitable, the NPV must be equal to or greater than zero regardless of its time basis. The NPV₀ as calculated using Equation 5 should be equal to or greater than zero at some point during the operational lifetime of an economically viable DAC device. The net present value (NPV) for a system that continues through an unlimited number of cycles can be viewed as a geometric sum of NPV₀ weighted with the discount factor. As such, it is optimal to maximize the value of NPV₀ for an increased TEA score.

In some examples, as shown in FIG. 15, the sorbent particle concentration may vary from 0% (which includes no sorbent particles) to 100% (which includes a sorbent article which only includes sorbent particles), where X1% is a value between 0% and 100%. In a known example shown by line 1500, the TEA score of the sorbent article is at a maximum value of Y1 when the sorbent particle concentration is at X1%, where X1 may be from 50% to 60%, from 60% to 70%, from 70% to 80%, or any other suitable range therebetween, and thereafter decreases between X1% to 100% concentration. In the example 1500, the remaining portion of the sorbent article that is not occupied by the sorbent particles is left empty (or, in other words, air occupies the remaining space). The reduction in TEA score for the example 1500 past X1% sorbent concentration is due to the negative effect(s) that a higher concentration of sorbent particles may have on other factors contributing to the TEA score, such as cost, capacity, life cycle, and kinetics of the resulting sorbent article. That is, beyond X1%, the benefit of having additional sorbent particles to capture CO₂ from the atmosphere would be offset in a manner of diminishing returns by other factors such as an increased cost or a reduced air flow efficiency, etc., thereby decreasing the TEA score.

In comparison, an example implementing the mixture as disclosed herein, shown using the dotted line 1502, reaches a higher TEA score of Y2 at X2%, where X2% is another number less than 100% but greater than X1%. For example, although the concentration of the sorbent particles increases with respect to the example 1500, the sorbent article of example 1502 does not experience the reduction of TEA score as was experienced in the example 1500, due to the additive particles included in the mixture. For example, the additive materials may increase the TEA score by offering benefits including but not limited to reduced cost, increased capacity, increased life cycle, or improved kinetics of the sorbent particles using any suitable means and materials as disclosed herein. Therefore, the inclusion of the additive particles in the example 1502 is beneficial in offering additional advantages as compared to only filling the sorbent article with sorbent materials as per the example 1500.

The disclosure of this application has been described above both generically and with regard to specific embodiments. It will be apparent to those skilled in the art that various combination, modifications, and variations can be made in the embodiments without departing from the scope of the disclosure. Thus, it is intended that the embodiments cover the combination, modifications, and variations of this disclosure provided they come within the scope of the appended claims and their equivalents.

### Carbon Dioxide Removal Service Providers

Also disclosed herein are methods for removing gaseous carbon dioxide (CO₂) from the atmosphere using any suitable means, methods, processes, or devices for atmospheric CO₂ removal as disclosed herein. In some examples, a carbon dioxide removal service provider that may be a person, a device, an atmospheric processing facility, a carbon dioxide removal plant, software, an internet site, an electronic interface, an organization, or a corporate agent or entity (that may include a control center, a headquarters, a data management center, an intermediary data collection or processing center, or facilitating organizations that provide information and/or control functions for or services to the provider) or an electronic device or display associated with or accessible to the provider may receive and/or become aware of information about a dispersion of a first quantity of gaseous CO₂ in the atmosphere at a first location. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. In some examples, the information may be in the form of an electronic communication (e.g., first electronic communication) that includes information about the dispersion of the first quantity of gaseous CO₂ into the atmosphere at the first location that may be received from and/or provided to a computing and/or electronic display device.

The carbon dioxide removal service provider may initiate an immediate or subsequent separating of or a method of separating a second quantity of gaseous CO₂ at a second location which may be different from the first location. The second location may be located remote to the first location such as, for example, when the first location is in a populated commercial area and the second location is near a geothermal or other hazardous energy source that powers the separating process at the second location. The second quantity may be at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. In some examples, the separating may be initiated by the sending or transmitting of instructions or confirmation to a location that has the capability of performing such separating. In some examples, the separating may be performed by a carbon capture device capable of carrying out any method for separating gaseous CO₂ from a gas mixture in the form of ambient air, as disclosed herein. In some examples, the distance from the first location to the second location may be from 100 km to 200 km, from 200 km to 500 km, from 500 km to 800 km, from 800 km to 1000 km, from 1000 km to 2000 km, from 2000 km to 3000 km, from 3000 km to 4000 km, from 4000 km to 5000 km, from 5000 km to 6000 km, from 6000 km to 7000 km, from 7000 km to 8000 km, from 8000 km to 9000 km, from 9000 km to 10,000 km, from 10,000 km to 15,000 km, from 15,000 km to 20,000 km, or any other suitable value or range therebetween.

The carbon dioxide removal service provider may initiate a reporting of data regarding the second quantity that will be, is being, or has been removed from the atmosphere. The initiating may be initial steps taken to start an immediate or subsequent reporting of data that may be performed via any suitable means of electronic communication or data transmission which may be wired or wireless. In some examples, the reporting may involve the preparing of information to be included in such reporting or later reporting and the subsequent sending or transmitting of instructions or confirmation to another entity or device which has the capability of starting or fully performing such reporting. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication may be transmitted to the computing or display device. In some examples, the second electronic communication may be transmitted to an additional computing or display device that may be separate or different from the aforementioned computing or display device.

In some examples, the method for removing gaseous CO₂ from the atmosphere may involve a carbon dioxide removal service provider (as described above) that may receive and/or become aware of information about a first quantity of gaseous CO₂ which may include a dispersion of gaseous CO₂. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. Such quantity may represent the amount of gaseous CO₂ being dispersed at a location (e.g., in tons of CO₂) and/or the rate of dispersion (e.g., in tons of CO₂ per minute, hour, day, etc.). In some examples, the information may be received as an electronic communication from another entity or device which sends or transmits instructions concerning gaseous CO₂ removal as disclosed herein. In some examples, an electronic communication (e.g., first electronic communication) that includes information about the dispersion of the first quantity of gaseous CO₂ that may be received from and/or provided to a computing and/or electronic display device.

The carbon dioxide removal service provider may separate or begin separation of a second quantity of gaseous CO₂ from the atmosphere, where the second quantity is at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. In some examples, the separating may be performed by a carbon capture device capable of carrying out any method for separating gaseous CO₂ from a gas mixture in the form of ambient air, as disclosed herein.

The carbon dioxide removal service provider may report the data regarding the second quantity that will be, is being, or has been removed from the atmosphere. The reporting of data may be performed via any suitable means of electronic communication or data transmission which may be wired or wireless. In some examples, the reporting may be in response to receiving instructions or confirmation as transmitted from another entity or device which has the capability of starting or fully performing such reporting. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication may be transmitted to the computing or display device. In some examples, the second electronic communication may be transmitted to an additional computing or display device that may be separate or different from the aforementioned computing or display device.

In some examples, the method for removing gaseous CO₂ from the atmosphere may involve a carbon dioxide removal service provider (as described above) that may transmit, emit, or send out information about a dispersion of a first quantity of gaseous CO₂ into the atmosphere at a first location. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. The transmitting may be an emitting and/or a sending out performed via any suitable means of electronic communication or data transmission which may be wired or wireless that may not be received by the intended recipient or any recipient. In some examples, the information may be in the form of an electronic communication (e.g., first electronic communication) that includes information about the dispersion of the first quantity of gaseous CO₂ into the atmosphere at the first location that may be transmitted, emitted, and/or sent out to a computing device with such transmission, emitting, and/or sending out not necessarily being received by any recipient.

The carbon dioxide removal service provider may request an immediate or subsequent separating of or a method of separating a second quantity of gaseous CO₂ from the atmosphere at a second location. The second location may be located remote to the first location such as, for example, when the first location is in a populated commercial or industrial area and the second location is near a geothermal or other hazardous energy source that powers the separating process at the second location. The second quantity may be at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. The requesting of the separating or an initiation of the separating may be performed via any suitable means of electronic communication or data transmission which may be wired or wireless. In some examples, the requesting may be by sending, emitting, or transmitting of instructions to a start command to a location that has the capability of starting or fully performing such separating. In some examples, the separating may be performed by a carbon capture device capable of carrying out any method for separating gaseous CO₂ from a gas mixture in the form of ambient air, as disclosed herein. In some examples, the distance from the first location to the second location may be from 100 km to 200 km, from 200 km to 500 km, from 500 km to 800 km, from 800 km to 1000 km, from 1000 km to 2000 km, from 2000 km to 3000 km, from 3000 km to 4000 km, from 4000 km to 5000 km, from 5000 km to 6000 km, from 6000 km to 7000 km, from 7000 km to 8000 km, from 8000 km to 9000 km, from 9000 km to 10,000 km, from 10,000 km to 15,000 km, from 15,000 km to 20,000 km, or any other suitable value or range therebetween.

The carbon dioxide removal service provider may receive a reporting, an indication of such reporting, and/or an indication of an availability of data regarding the second quantity that will be, is being, or has been removed from the atmosphere. The receiving of the reporting does not require examination or review by a human, may be achieved by simply making the reporting accessible even if subsequently never reviewed or acknowledged, and/or may be performed via any suitable means of electronic communication or data transmission which may be wired or wireless. In some examples, the receiving of the reporting may regard the second quantity, such as how much of the gaseous CO₂ was separated within a predetermined amount of time, for example within a day, a week, a month, etc. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication is received from the computing device. In some examples, the second electronic communication is received in response to the transmitting of the first electronic communication. In some examples, the second electronic communication is received from the computing or display device in response to the transmitting of the first electronic communication to the computing or display device.

As used herein, “receiving” information is to be understood as an act of “receiving” which requires only one party (or entity, device, etc.) to perform, such that a separate party for performing the act of “sending” is not required.

As used herein, “initiating” a separating (or a method of separating) is to be understood as an act of “initiating” that includes an initial or completed act of preparing or dispatching instructions to another party or device with the intent that there is an execution or start of a separating process or the association of an already started separating process with the initiating step. For example, the act of “initiating” the separating of gaseous CO₂ may cause a carbon capture device to subsequently receive an instruction, either directly or indirectly (e.g., via intermediary entities or devices) to initiate the separating, in response to which the carbon capture device operates accordingly. In another example, the act of “initiating” a separating (or a method of separating) gaseous CO₂ may include a carbon dioxide removal service provider associating carbon dioxide that has already been removed from the atmosphere (or presently in an active removal process) with a subsequent initiating of a separating. It will be appreciated that the instruction received by the carbon capture device need not be provided as part of such an “initiating” operation. Further, the act of “separating” of the CO₂, for example, is therefore not necessarily part of the act of “initiating” such separating, such as when the “initiating” of the separating is performed by a first party and the subsequent “separating” itself is performed by a second party different from the first party. Furthermore, the act of “separating” does not need to be accomplished or fully completed, either by the first party or the second party. It will also be appreciated that the act of initiating can be fully performed in one jurisdiction or country even though an acknowledgement of the initiating or an act subsequent to or associated with the initiating takes place in a different jurisdiction or country.

As used herein, “initiating” a reporting (e.g., of data) is to be understood as an act of “initiating” that includes the initial or complete act of preparing or dispatching instructions to another party to prepare, start, or complete the reporting at a later time. The act of “reporting” any data, for example, is therefore not necessarily part of the act of “initiating” such reporting, such as when the “initiating” of the reporting is performed by a first party (the initiating party) and the “reporting” itself is performed by a second party (the reporting party) different from the first party (the initiating party). Furthermore, the act of “reporting” does not need to be accomplished or fully completed, either by the first party or the second party. It will be appreciated that the act of initiating can be fully performed in one jurisdiction or country even though an acknowledgement of the initiating or an act subsequent to or associated with the initiating takes place in a different jurisdiction or country.

As used herein, “reporting” data is to be understood as an act of “reporting” which may require only one party (reporting party) to perform. Furthermore, the act of “reporting” does not require the receipt (or confirmation of receipt) of such reporting by another party (receiving party). The reporting may be a storage of the data or display of the data at a location that is accessible to an intended recipient, and may still be considered to be a reporting even when the intended recipient does not access or review the data.

As used herein, “transmitting” information is to be understood as an act of “transmitting” which may require only one party (the transmitting party) to perform. Furthermore, the act of “transmitting” does not require a receiver (e.g., receiving party) or receipt (e.g., confirmation of receipt) of the information that is transmitted.

As used herein, “requesting” a separating (or initiation of a method of separating) is to be understood as an act of “requesting” which may require only one party (the requesting party) to perform. Also, the act of “separating” which is requested by the act of “requesting” may be performed by another party (the separating party). Furthermore, the act of “requesting” may be only intended or started and does not need to be accomplished or fully completed (e.g., when no separating results from the act of “requesting” such separating). In an example, the act of “requesting” a separating (or initiation of a method of separating) of gaseous CO₂ may include a carbon dioxide removal service provider associating carbon dioxide that has already been removed from the atmosphere (or presently in an active removal process) with a subsequent request for a separating. It will be appreciated that the act of requesting can be fully performed in one jurisdiction or country even though an acknowledgement of the requesting or an act subsequent to or associated with the requesting takes place in a different jurisdiction or country.

As used herein, “receiving” a reporting or an indication of the reporting is to be understood as an act of “receiving” which does not require a sender (e.g., sending party). The receiving may be a storage of the data or display of the data at a location that is accessible to an intended recipient, and may still be considered to be a receiving even when the intended recipient does not access or review the data.

As can be appreciated, the first quantity, the second quantity, and the portion of the first quantity may be estimated or projected values. It can be further appreciated that carbon dioxide gas released or dispersed at the first location may not necessarily include or be the same CO₂ molecules separated or collected at the second location, and that the second quality may be an equivalent quantity of CO₂ that was released or dispersed. The CO₂ in the portion of the first quantity may be in a non-gaseous form. The portion of the first quantity or the second quantity may refer to carbon dioxide that is entrapped in the sorbent as disclosed herein or that has been stored or otherwise converted into another form. The portion of the first quantity or the second quantity may also include gases other than carbon dioxide. For example, the second quantity may be in a non-gaseous form or combined with other materials.

As used herein, a “carbon capture device” refers to any one or more devices as disclosed herein that is capable of separating gaseous CO₂ from the atmosphere at the location at which the device is installed or located. The carbon capture device may refer to a single device or a plurality of devices, or a facility containing therein one or more such devices or component devices that act in concert. The device may include, for example, the desorbing media source(s) and the adsorber structure(s) as disclosed herein. The device may be operable by a user or operator using an electronic device. The device may generate data associated with its operation, for example as may be detected by one or more sensors and/or as may include log data, among other examples.

As used herein, an “electronic device” is capable of performing one or more electronic operations, for example a computer, smartphone, smart tablet, etc. The electronic device may include for example a display device and/or one or more processing units and one or more memory units. The processing unit may include a central processing unit (CPU), a microprocessor, system on a chip (SoC), or any other processor capable of performing such operations. The memory unit may by a non-transitory computer-readable storage medium storing one or more programs or instructions thereon which, when run on the processing unit, causes the processing unit or the electronic device to perform one or more methods as disclosed herein. The memory unit may include one or more memory chips capable of storing data and allowing storage location to be accessed by the processing unit(s), for example a volatile or non-volatile memory, static or dynamic random-access memory, or any variant thereof. In some examples, the electronic device may be referred to as a computing device.

Technical advantages of removing gaseous CO₂ from an atmosphere using the methods or processes as disclosed herein includes, but are not limited to, facilitating a network of entities and/or devices that are capable of communicating with other entities and/or devices in order to remotely provide instructions or facilitating separation and removal of gaseous CO₂ without requiring to be physically at the location to do so. Furthermore, the methods and processes as disclosed herein provide a robust network of interinstitutional communication such that each entity (which may be an institution associated with a physical location) is capable of directing or initiating the separation and removal of gaseous CO₂ at multiple locations simultaneously, as well as having the capability of flexibly changing the location at which separation and removal of gaseous CO₂ is determined to be removed. The change in location may be performed at or near real-time such that there is minimal time lag between when the instructions are provided and when the separating of gaseous CO₂ takes place at the designated location, for example. In some examples, the methods or processes as disclosed herein provides a flexible communication network in which the entity or device which performs the separation and removal of gaseous CO₂ at the designated location may provide a timely reporting (e.g., operation summary and/or invoice for the service rendered) associated with the amount of gaseous CO₂ that was removed during a predetermined time period. Such reporting may be generated automatically or manually, may be generated at a predetermined time interval (e.g., once every day, week, month, etc.) or more flexibly as manually determined (e.g., each time a user or entity requests), or may be generated in response to achieving or exceeding a predetermined threshold, including but not limited to the amount of gaseous CO₂ that was separated and removed from the atmosphere (e.g., every 1 ton, 5 tons, 10 tons, etc., of gaseous CO₂ that was removed from the atmosphere), and any other suitable conditions as determined and agreed upon by the entities involved, for example.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What is claimed is:

1. A sorbent polymer composite article comprising:
a polymer region having a constant volume;
a plurality of expandable particles disposed within the polymer region, the plurality of expandable particles having a first configuration with a first total volume of the plurality of expandable particles and a second configuration with a second total volume of the plurality of expandable particles greater than the first total volume of the plurality of expandable particles; and
a plurality of compressible particles disposed within the polymer region, the plurality of compressible particles having a first configuration with a first total volume of the plurality of compressible particles and a second configuration with a second total volume of the plurality of compressible particles greater than the first total volume of the plurality of compressible particles,
wherein the plurality of expandable particles impart a force to the plurality of compressible particles when the plurality of expandable particles transition from the first configuration of the plurality of the expandable particles to the second configuration of the plurality of expandable particles to compress the plurality of compressible particles from the second configuration of the plurality of compressible particles to the first configuration of the plurality of compressible particles to maintain the constant volume of the polymer region.

2. The article of claim 1, wherein the polymer region includes a porous polymer configured to hold the plurality of expandable particles and the plurality of compressible particles inside the polymer region.

3. The article of claim 1, wherein the plurality of expandable particles have the first configuration of the plurality of expandable particles during an adsorption process and the second configuration of the plurality of expandable particles during a desorption process.

4. The article of claim 1, wherein the plurality of expandable particles change from having the first configuration of the plurality of expandable particles to having the second configuration of the plurality of expandable particles in response to an increase in humidity.

5. The article of claim 4, wherein the increase in humidity is in response to changing from an adsorption process to a desorption process or during the desorption process.

6. The article of claim 4, wherein the plurality of expandable particles change from having the first configuration of the plurality of expandable particles to having the second configuration of the plurality of expandable particles in response to a decrease in temperature to below a freezing point of water.

7. The article of claim 1, wherein the plurality of expandable particles are made of one or more of: an ion exchange resin, zeolite, activated carbon, alumina, metal-organic frameworks, or polyethyleneimine (PEI).

8. The article of claim 1, wherein the plurality of compressible particles are made of one or more of: foams, expanded polystyrene beads, or latex microspheres.

9. The article of claim 1, further comprising a plurality of structurally stable particles disposed within the polymer region.

10. The article of claim 9, wherein the structurally stable particles are configured to provide protection for the sorbent polymer composite article from mixing with water, provide protection for the sorbent polymer composite article from oxidation, or facilitate heating of the sorbent polymer composite article.

11. The article of claim 9, wherein the structurally stable particles include a combination of one or more of: ceramic particles, metal particles, or graphite particles.

12. The article of claim 1, wherein the constant volume is defined by a total volume of the polymer region changing by less than about 10%, less than about 5%, or less than about 1%.

13. A sorbent polymer composite article comprising:
a polymer region having a constant volume and defining a plurality of interstitial spaces therein having a first configuration with a first total volume of the plurality of interstitial spaces and a second configuration with a second total volume of the plurality of interstitial spaces greater than the first total volume;
a plurality of expandable particles disposed within a portion of the interstitial spaces, the plurality of expandable particles having a first configuration with a first total volume of the plurality of expandable particles and a second configuration with a second total volume of the plurality of expandable particles greater than the first total volume,
wherein the plurality of expandable particles impart a force to the plurality of interstitial spaces when the plurality of expandable particles transition from the first configuration of the plurality of the expandable particles to the second configuration of the plurality of expandable particles to compress the plurality of interstitial spaces from the second configuration of the plurality of interstitial spaces to the first configuration of the plurality of interstitial spaces to maintain the constant volume of the polymer region.

14. The article of claim 13, wherein the polymer region includes a porous polymer configured to hold the plurality of expandable particles inside the polymer region.

15. The article of claim 13, wherein the plurality of expandable particles have the first configuration of the plurality of expandable particles during an adsorption process and the second configuration of the plurality of expandable particles during a desorption process.

16. The article of claim 13, wherein the plurality of expandable particles change from having the first configuration of the plurality of expandable particles to having the second configuration of the plurality of expandable particles in response to an increase in humidity.

17. The article of claim 13, wherein the plurality of expandable particles occupy no greater than about 50% of the second total volume of the plurality of interstitial spaces of the polymer region.

18. The article of claim 13, further comprising a plurality of structurally stable particles disposed within the polymer region, wherein the force imparted by the plurality of expandable particles pushes the plurality of structurally stable particles into the plurality of interstitial spaces, wherein the structurally stable particles provide protection for the sorbent polymer composite article from mixing with water, provide protection for the sorbent polymer composite article from oxidation, or facilitate heating of the sorbent polymer composite article.

19. The article of claim 13, further comprising a plurality of compressible particles disposed within the polymer region and configured to absorb at least a portion of the force imparted by the plurality of expandable particles.

20. The article of claim 13, wherein the constant volume is defined by a total volume of the polymer region changing by less than about 10%, less than about 5%, or less than about 1%.
